(19) United States
(12) Patent Application Publication
(10) Pub. No.: US 2025/0183714 A1
(43) Pub. Date: Jun. 5, 2025

(54) DISPLACED RECEIVER DETECTION IN A WIRELESS POWER SYSTEM AND RELATED APPARATUSES, METHODS, AND SYSTEMS

(71) Applicant: Microchip Technology Incorporated, Chandler, AZ (US)

(72) Inventor: Santosh Bhandarkar, Chandler, AZ (US)

(21) Appl. No.: 18/962,376

(22) Filed: Nov. 27, 2024

Related U.S. Application Data
(60) Provisional application No. 63/604,268, filed on Nov. 30, 2023.

(51) Int. Cl. H02J 50/10; H02J 50/40; H02J 50/60

(52) U.S. Cl. CPC H02J 50/10; H02J 50/40; H02J 50/60

(57) ABSTRACT

A method comprises generating a wireless power signal in one or more transmit coils of a transmitter which inductively couple with one or more receive coils of a receiver for wireless power transfer; terminating the wireless power transfer at least partially responsive to detecting a power loss of the wireless power transfer to be greater than a power loss threshold when a power factor of the wireless power transfer is greater than a power factor threshold; and refraining from terminating the wireless power transfer at least partially based on the power factor being less than the power factor threshold.

### CROSS-REFERENCE TO RELATED APPLICATION

This application claims the benefit under 35 U.S.C. § 119(e) of U.S. Provisional Patent Application Ser. No. 63/604,268, filed Nov. 30, 2023, the disclosure of which is hereby incorporated herein in its entirety by this reference.

### TECHNICAL FIELD

This disclosure relates generally to displaced receiver detection in a wireless power system, and more particularly to displaced receiver detection by a transmitter of a wireless power system based on power computations associated with wireless power transfer. Additionally, methods, apparatuses, and systems are disclosed.

### BACKGROUND

Wireless power transfer techniques are widely used to transfer power from one system to another in a wide range of applications. Qi is the most widely-adopted wireless charging standard and it has proliferated into nearly all consumer cell phone brands.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 is a schematic block diagram of a wireless power system, according to various examples;

FIG. 2 is a more detailed schematic block diagram of the wireless power system of FIG. 1, according to one or more examples;

FIG. 3 is a circuit diagram of a transmitter without a power filter, according to one or more examples;

FIG. 4 is a circuit diagram of a transmitter including a power filter, according to one or more examples;

FIG. 5 is a circuit diagram of a transmitter without a power filter, according to one or more examples;

FIG. 6 is a circuit diagram of a transmitter including a power filter, according to one or more examples;

FIGS. 7A, 7B, and 7C are respective plots of capacitor and coil voltage waveforms associated with a receiver under various load conditions;

FIG. 8 is a flowchart of a method of performing a direct memory access (DMA) initialization associated with a DMA module, according to one or more examples;

FIG. 9 is a flowchart of a method of performing a data acquisition process associated with a DMA module, according to one or more examples;

FIG. 10A is a flowchart of a method of performing power loss calculations for foreign object interference detection, according to one or more examples;

FIG. 10B is a flowchart of a method of performing power computations associated with displaced receiver detection, according to one or more examples;

FIG. 11 is a flowchart of a method of initializing or setting a threshold for assessment of a power factor (PF) associated with wireless power transfer, according to one or more examples;

FIG. 12 is a flowchart of a method of performing computations and computational assessments associated with displaced receiver conditions, according to one or more examples;

FIG. 13 is an example timeline of events and actions associated with the methods described in relation to FIGS. 10A-10B, 11, and 12;

FIG. 14 is a plot of a function or relation of power loss threshold ratios versus power level ratios for re-computing a power loss threshold, according to one or more examples;

FIG. 15 is a flowchart of a method of controlling operation of a transmitter for wireless power transfer, according to one or more examples;

FIG. 16A is a system for wireless power transfer, according to one or more examples;

FIG. 16B is the wireless power system of FIG. 16A, where the receiver is displaced relative to a predetermined charging position on the transmitter, according to one or more examples; and

FIG. 17 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples in which the present disclosure may be practiced. These examples are described in sufficient detail to enable a person of ordinary skill in the art to practice the present disclosure. However, other examples enabled herein may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. In some instances similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an examples or this disclosure to the specified components, steps, features, functions, or the like.

It will be readily understood that the components of the examples as generally described herein and illustrated in the drawings could be arranged and designed in a wide variety of different configurations. Thus, the following description of various examples is not intended to limit the scope of the present disclosure, but is merely representative of various examples. While the various aspects of the examples may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the examples disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Wireless power transfer techniques are used to transfer power from one system to another in a wide range of applications. Qi is a wireless charging standard that is a widely-adopted standard that has proliferated into consumer cellular telephone applications.

By way of example, a Qi wireless system includes a wireless power transmitter (“transmitter”) and a wireless power receiver (“receiver”). For wireless power transfer (e.g., for wireless charging), the receiver is placed on the transmitter (e.g., on a surface of a housing of the transmitter). The transmitter includes at least one transmit coil with which the receiver coil is coupled (i.e., inductively coupled) when placed thereon. In a multi-coil transmitter design, there are multiple transmit coils overlapping each other so the receiver coil can be placed over any of the transmit coils (e.g., to provide further spatial freedom for receiver placement).

The extent or quality of the mutual coupling between the receiver and transmitter will vary based on the placement of the receiver relative to an intended rest position (e.g., a center) of the transmitter. If the coupling is good, wireless power transfer is initiated by the transmitter. If the coupling is poor, the transmitter reserves the right to not initiate the wireless power transfer due to poor efficiency.

For wireless power transfer, the transmitter generates a wireless power signal in the at least one transmit coil at an operating frequency (e.g., between 110 kHz to 148 kHz). The transmitter controls the level of power transferred to the receiver based on receiver feedback. In one or more examples, the receiver communicates feedback by sending an eight (8) bit signed integer representing a control error (CE) value. Responsive to the control error value, the transmitter increases or decreases the power level to the receiver by adjusting the voltage or the operating frequency. This may be repeated one or more times in a control loop for an eventual reduction of the control error to zero.

In one or more specific examples, communication from the receiver to the transmitter is performed in-band, over the operating frequency used for wireless power transfer, by altering electrical load characteristics at the receiver. The receiver causes changes in the characteristics using, for example, a switching resistance or a switching capacitance. The change in the capacitance or resistance at the receiver causes a change in coil voltage or coil current at the transmitter. The changes may appear at the transmitter as a bit stream (e.g., varying between 1 kilohertz (kHz) to 2 kHz) riding over the operating frequency.

After power transfer is initiated with good coupling between the receiver and the transmitter, the receiver may slide or move over the transmitter's surface (e.g., a smooth and/or unobstructed top surface of a housing or container of the transmitter) in sudden or gradual increments over time. This movement typically occurs in automotive applications where the receiver is displaced by vehicle vibrations or movement. The receiver may eventually be shifted or moved away from the intended rest position to a displaced position, where coupling with the transmitter is poor. Such a receiver or condition may be referred to as a “sliding receiver” or “sliding receiver condition,” “misaligned receiver” or “misaligned receiver condition” associated with a “misalignment,” or “displaced receiver” or “displaced receiver condition” associated with a “displacement.”

Operating efficiency is dependent on the coupling between the receiver and the transmitter coils, with maximum efficiency when the coils are (e.g., directly) over each other. When the receiver is moved to a displaced position (e.g., away from its intended rest position), the coupling factor between the receiver and the transmitter is reduced. In a high vibration environment, such as an automotive environment, it is desirable to accommodate for spatial movement between the receiver and the transmitter.

To maintain customer satisfaction, transmitter designs may specify the continued supply of power at weaker couplings (e.g., at displaced receiver conditions) as a guarantee of receiver charging. Thus, in many instances, continued wireless power transfer to the displaced receiver is desirable despite the non-ideal charging position of the receiver. In response to weaker couplings, the transmitter's control loop for power transfer increases the voltage, or decreases the operating frequency, to maintain the (e.g., same) power level at the receiver. In some cases, misalignments between the receiver and the transmitter result in higher voltage and currents in the transmitter as well as higher temperatures.

In the above-described operating scenarios, increasing the voltage or decreasing the operating frequency to maintain receiver power level increases the difference between the transmitted power and the receiver power—that is, it increases power loss in the wireless power transfer. The inventor of this disclosure appreciates that detected power loss is the basis for the detection of foreign object (FO) interference. Detection of foreign object interference may necessitate the stopping or termination of wireless power transfer. Thus, if a receiver is moved substantially, the power loss associated with the receiver displacement could falsely trigger the detection of foreign object interference when no foreign object is actually present.

The inventor of this disclosure appreciates that detection techniques become complicated when the control variable used for power transfer (e.g., voltage or frequency) is used for the detection of receiver displacement. For example, if the control variable is voltage, the voltage may be used for monitoring (e.g., directly or indirectly) receiver displacement, where receiver load conditions do not otherwise change substantially over time (e.g., typically, when the state of a cell phone battery does not change over a relatively small time interval). However, the voltage change behavior associated with foreign object interference is similar to the voltage change behavior associated with receiver displacement.

More particularly, when a foreign object is placed between the transmitter and receiver, some of the energy transmitted by the transmitter does not reach the receiver, as it is absorbed by the foreign object. As a result, the receiver detects a drop in its load voltage and requests the transmitter to increase the voltage. These detected conditions and behaviors are the same as or similar to those associated with displacement of a receiver with a weaker coupling coefficient. As is apparent, it may be challenging to distinguish whether increases in voltage are the result of foreign object interference or receiver displacement.

As mentioned above, a transmitter's response to foreign object interference detection may be different from a transmitter's response to receiver displacement detection. In the case of detection of a foreign object, the transmitter may (altogether) stop supplying power to the receiver (without which the foreign object would continue to heat). In the case of detection of a displaced receiver, the transmitter may not stop supplying the power (but rather continue supplying the power) to the receiver. Hence, reliable detection and distinguishment between foreign object interference and receiver displacement is desirable for appropriate wireless power transfer operation.

Various examples disclosed herein relate to detection of a displaced receiver at a transmitter of a wireless power system. In various examples, the transmitter detects a displaced receiver condition at least partially responsive to detection of a power factor that is less than a power factor threshold.

Various examples disclosed herein also relate to detection of a displaced receiver at the transmitter as distinguished from detection of foreign object interference at the transmitter. In one or more examples, the transmitter stops or terminates wireless power transfer to the receiver responsive to detection of foreign object interference (e.g., a detection associated with a detected power loss). In one or more examples, the transmitter refrains from stopping or terminating the wireless power transfer to the receiver responsive to detection of a displaced receiver (e.g., a detection associated with the same or similar detected power loss). The latter ensures continued power transfer in cases merely where coupling between the transmitter and the receiver is poor.

In one or more examples, the transmitter is to stop or terminate the wireless power transfer to the receiver responsive to detecting a power loss that is greater than a power loss threshold, indicating foreign object interference. However, the transmitter may change (e.g., increase) the power loss threshold used for detecting foreign object interference responsive to detection of receiver displacement.

In one or more examples, the transmitter changes an operating point of the wireless power transfer, one or more times as needed, to identify any improvement in efficiency in the continued power transfer. For example, if voltage is used as the control variable, the transmitter may (repeatedly) change the operating frequency toward a resonant point responsive to detection of a displaced receiver. In one or more examples, the transmitter may limit the power level to the receiver in response to detection of a displaced receiver with an extreme misalignment.

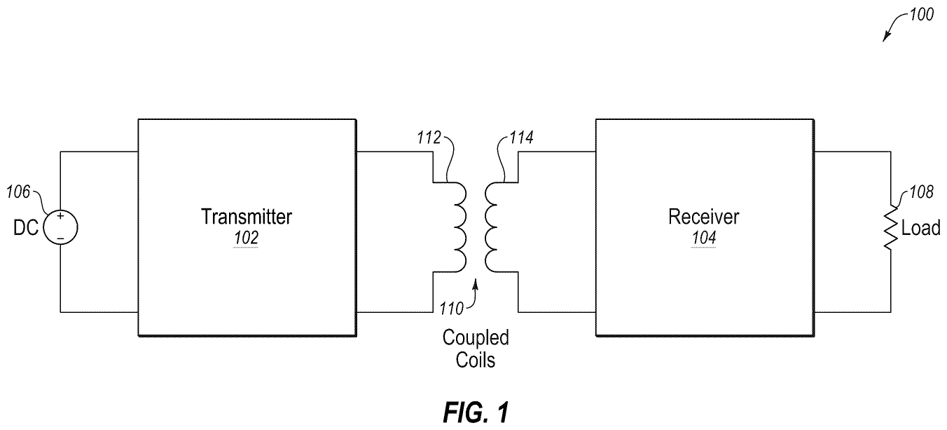

FIG. 1 is a schematic block diagram of a wireless power system 100, according to one or more examples. Wireless power system 100 includes a transmitter 102 and a receiver 104. Transmitter 102 may be referred to as a wireless power transmitter for wireless power transfer, and receiver 104 may be referred to as a wireless power receiver.

Transmitter 102 is powered by a DC voltage source 106, and receiver 104 is connected to a load 108. The power is transferred from transmitter 102 to receiver 104 through a set of coupled coils 110 (i.e., from a transmitter coil 112 to a receiver coil 114). Transmitter 102 may control the power transferred by controlling the input voltage, frequency, phase, and/or duty cycle of the signal applied to transmitter coil 112. Power is transferred by magnetic flux linkage; there is no physical connection between transmitter 102 and receiver 104. The power transmission is most efficient when transmitter and receiver coils 112 and 114 are placed one over the other and are aligned.

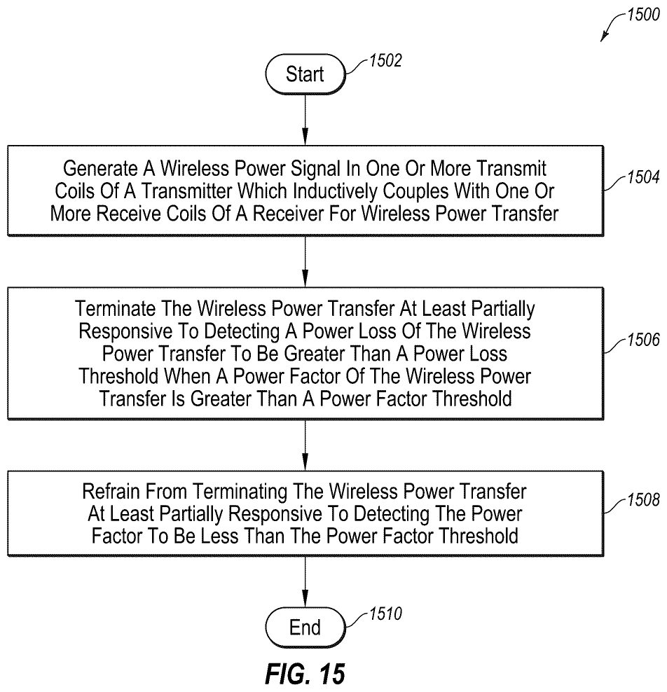

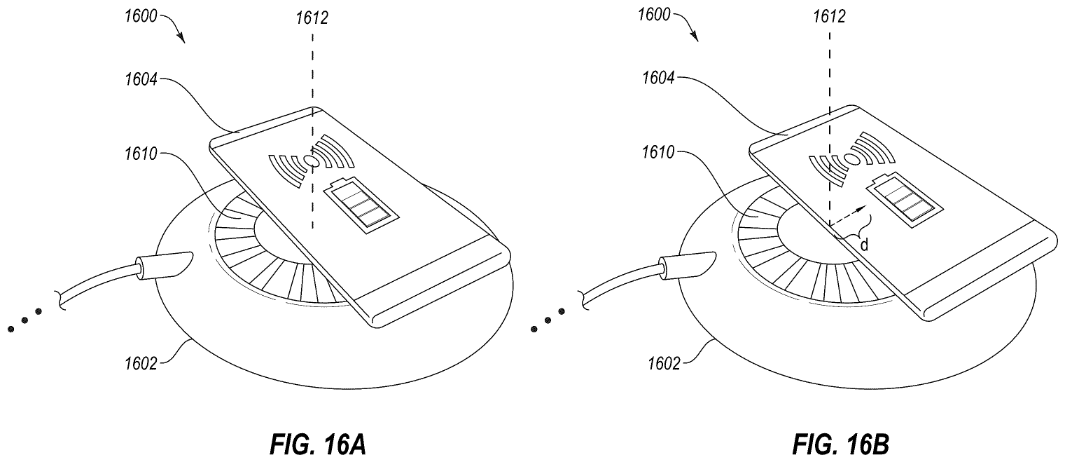

In a specific, non-limiting example, a mobile device (e.g., a cellphone or smart phone) may be powered by one or more batteries and include receiver 104. The mobile device including receiver 104 may be placed on a mobile phone charger including transmitter 102 for wirelessly charging the one or more batteries of the mobile device. Such a system is shown and described later below in relation to FIGS. 16A-16B.

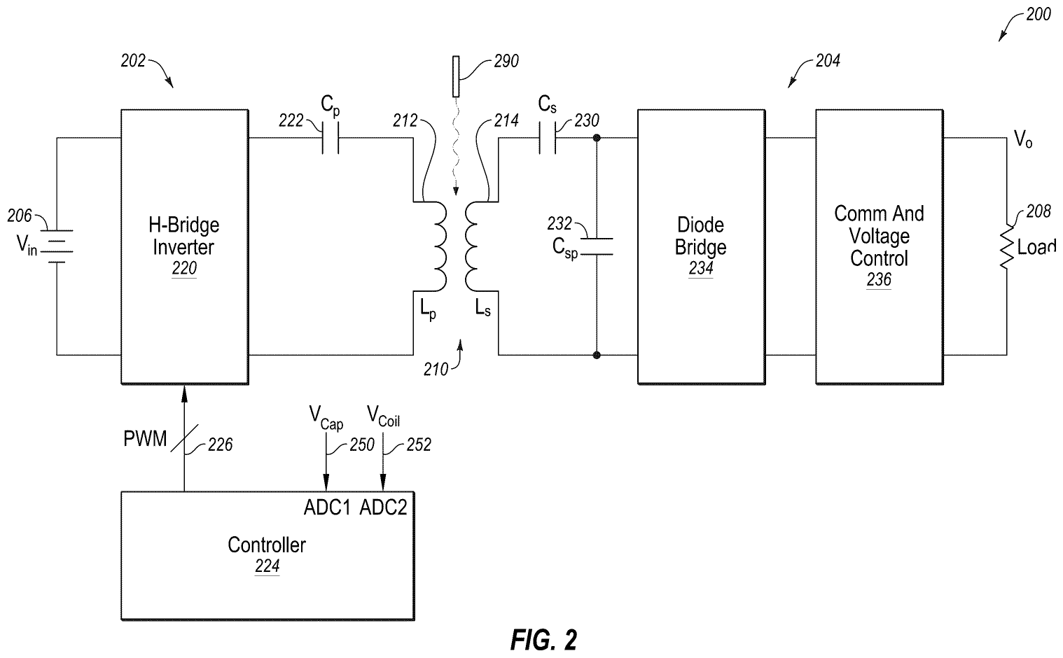

FIG. 2 is a more detailed schematic block diagram of a wireless power system 200 without a power filter, according to one or more examples. Like the wireless power system of FIG. 1, wireless power system 200 of FIG. 2 includes a transmitter 202 and a receiver 204. In one or more examples, transmitter 202 is included as part of a first device or unit and receiver 204 is included as part of a second device or unit; the second device or unit may be separate and apart from the first device or unit (e.g., the second device or unit may be movable and relocatable independent of the first device or unit).

Transmitter 202 is powered by a DC voltage source 206, and receiver 204 is connected to a load 208. In general, power is transferred from transmitter 202 to receiver 204 through a set of coupled coils 210 (i.e., from a transmitter coil 212 (Lₚ) of transmitter 202 to a receiver coil 214 (Lₛ) of receiver 204).

Transmitter 202 includes an H-bridge inverter 220 and a capacitor 222 (Cₚ) electrically connected in series with transmitter coil 212. Capacitor 222 may be referred to as a transmitter tank capacitor, and more generally as a series capacitor. A controller 224 may drive H-bridge inverter 220 with pulse-width modulated (PWM) signals 226 or pulses. In one or more examples, controller 224 may be a microcontroller, such as a dsPIC microcontroller, without limitation. In one or more examples, the PWM signals 226 may be either a fixed frequency or a variable frequency, which may depend on the particular topology of transmitter 202.

Receiver 204 includes a capacitor 230 (Cₛ), a capacitor 232 (Cₛₚ), a bridge rectifier 234 (diode bridge), and communication and voltage control circuitry 236. Capacitor 230 is electrically connected in series with receiver coil 214, and capacitor 232 is electrically connected in parallel with the series-connected capacitor 230 and receiver coil 214. Capacitor 230 (Cₛ) may be referred to as a receiver tank capacitor, and more generally as a series capacitor. A resonant tank circuit is formed by receiver coil 214 and capacitors 230 and 232. The output of the resonant tank circuit is passed through bridge rectifier 234, which rectifies the voltage. The output of bridge rectifier 234 is passed through either a buck converter or a low-dropout (LDO) regulator, which provides a fixed voltage at load 208.

As described herein, transmitter 202 operates to detect a displaced receiver condition of receiver 204 (e.g., receiver 204 is displaced relative to a predetermined charging position associated with transmitter 202). In one or more examples, transmitter 202 is to further detect whether a foreign object 290 is present between transmitter coil 212 and receiver coil 214 (“foreign object interference”). Controller 224 may compute a coil power of transmitter 202 as well as other power related values to enable such detections.

In one or more examples, controller 224 provides an input 250 to a first analog-to-digital converter (ADC) channel for sampling a capacitor voltage across capacitor 222 (Cₚ). A coil current may be computed based on the sampled capacitor voltages. As capacitor 222 is coupled in series with transmitter coil 212, the current through capacitor 222 is the same as the coil current. In addition, controller 224 provides an input 252 to a second ADC channel for sampling a coil voltage across transmitter coil 212 (Lₚ).

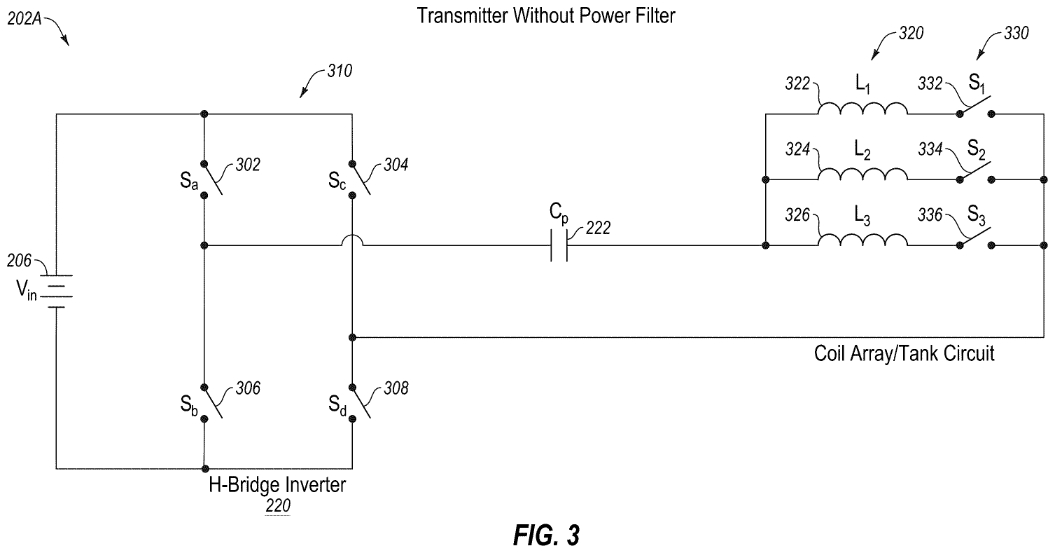

FIG. 3 is a circuit diagram of a transmitter 202A without a power filter, according to one or more examples. Transmitter 202A of FIG. 3 illustrates transmitter hardware, which may be used as transmitter 202 of FIG. 2. As shown in FIG. 3, transmitter 202A is a multi-coil transmitter.

H-bridge inverter 220 comprises multiple switches 310 including switches 302, 304, 306, and 308 (designated Sₐ, S_{b}, S_{c}, and S_{d}, respectively). In one or more examples, switches 302, 304, 306, and 308 are MOSFETs driven by MOSFET drivers. The controller (e.g., controller 224 of FIG. 2) may control of operation of H-bridge inverter 220. More specifically, the MOSFET driver inputs may be operably coupled to and/or controlled by PWM pins on the controller. In operation, switches 302 and 308 are turned on in the positive half cycle, and switches 304 and 306 are turned on in the other half cycle. In one or more examples, the frequency of operation may be fixed at 125 kHz for the selected topology.

Transmitter 202A includes a coil array 320 of multiple coils 322, 324, and 326 (designated L₁, L₂, and L₃, respectively). Multiple switches 330 include switches 332, 334, and 336. Respective coils 322, 324, and 326 of coil array 320 are coupled in series with a respective one of switches 332, 334, and 336 (designated S₁, S₂, and S₃, respectively). In one or more examples, transmitter 202A includes only a single coil.

Capacitor 222 has a first end coupled between switches 302 and 306 and a second end coupled to ends of coils 322, 324, and 326. A resonant tank circuit may be formed by capacitor 222 (Cₚ) and a selected one of coils 322, 324, and 326 connected across an output of H-bridge inverter 220. The input to H-bridge inverter 220 may come directly from the source or from an output of a four-switch buck boost converter (FSBBC), which controls the input voltage to H-bridge inverter 220.

H-bridge inverter 220 applies an AC voltage across the resonant tank circuit formed by capacitor 222 and the selected one of coils 322, 324, and 326. When one of switches 332, 334, and 336 is closed, it places a respective one of coils 322, 324, and 326 in the resonant tank circuit (only one of coils 322, 324, and 326 is connected to H-bridge inverter 220 at a time). In one or more examples, switches 332, 334, and 336 may be made of back-to-back MOSFETs for conducting bidirectional AC current in the resonant tank circuit. These switches may be controlled by the controller and may be switched as described.

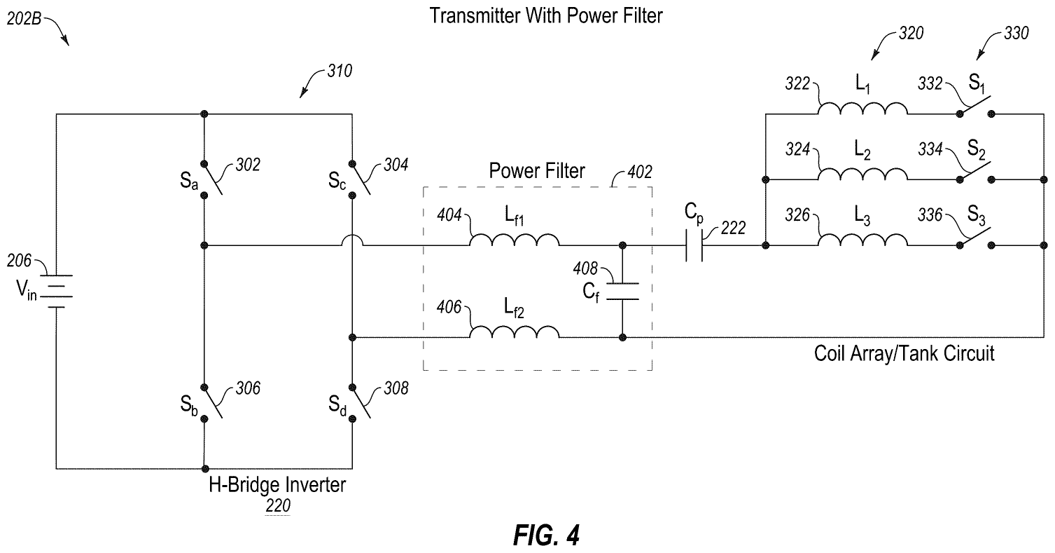

FIG. 4 is a circuit diagram of a transmitter 202B including a power filter 402, according to one or more examples. Transmitter 202B of FIG. 4 is the same as the transmitter of FIG. 3 but includes power filter 402. Transmitter 202B of FIG. 4 may be used as transmitter 202 of FIG. 2.

Power filter 402 includes an additional LC filter between H-bridge inverter 220 and the resonant tank circuit. Power filter 402 includes an inductor 404 (L_{f1}), an inductor 406 (L_{f2}), and a capacitor 408 (C_{f}). Inductor 404 is coupled in series with capacitor 222 and has an end coupled between switches 302 and 306. Inductor 406 has a first end coupled between switches 304 and 308 and a second end coupled to ends of switches 332, 334, and 336. Capacitor 408 has a first end coupled between capacitor 222 and inductor 404 and a second end coupled to the second end of inductor 406.

The resonant frequency of power filter 402 is much higher than the resonant frequency of the resonant tank circuit. Power filter 402 is included to apply only the fundamental switching frequency to the resonant tank circuit. Without power filter 402, a square wave waveform including a fundamental frequency and odd harmonics would be applied to the resonant tank circuit. Power filter 402 reduces high frequency electromagnetic (EM) radiation from being produced from transmitter 202B.

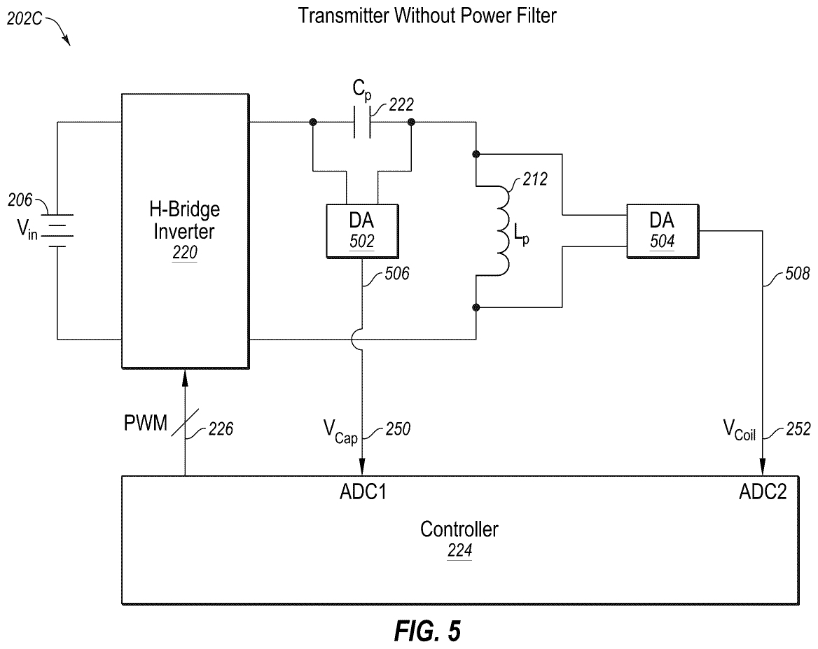

FIG. 5 is a circuit diagram of a transmitter 202C without a power filter, according to one or more examples. In one or more examples, transmitter 202C of FIG. 5 is similar to transmitter 202 of FIG. 2 and may be used as transmitter 202 of FIG. 2.

As described previously, controller 224 may compute a coil power of transmitter 202 as well as other power related values for detection of a displaced receiver and/or foreign object interference. In one or more examples, controller 224 provides input 250 to a first ADC channel for sampling capacitor voltage across capacitor 222 (Cₚ). A coil current may be computed based on the sampled capacitor voltages. As capacitor 222 is coupled in series with transmitter coil 212, the current through capacitor 222 is the same as the coil current. A differential amplifier 502 is used to provide a capacitor measurement signal indicative of a capacitor voltage potential difference across capacitor 222. Differential amplifier 502 includes a first input terminal and a second input terminal electrically connected across capacitor 222, and an output 506 coupled to input 250 to the first ADC channel.

In addition, controller 224 also provides input 252 to second ADC channel for sampling coil voltage across transmitter coil 212 (Lₚ). A differential amplifier 504 is used to provide a coil measurement signal indicative of a coil voltage potential difference across transmitter coil 212. Differential amplifier 504 includes a first input terminal and a second input terminal electrically connected across transmitter coil 212, and an output 508 coupled to input 252 to the second ADC channel.

Thus, two (2) dedicated ADCs capable of sampling the input at a very high rate may be utilized. By way of non-limiting example, about twenty (20) samples may be taken per cycle of 120 kHz, resulting in a sampling frequency of 2.4 MHz. The two dedicated ADCs may be triggered by the same signal, such that high frequency sampling may be performed simultaneously. The simultaneous sampling may ensure that sampling and processing delays are identical for both signals.

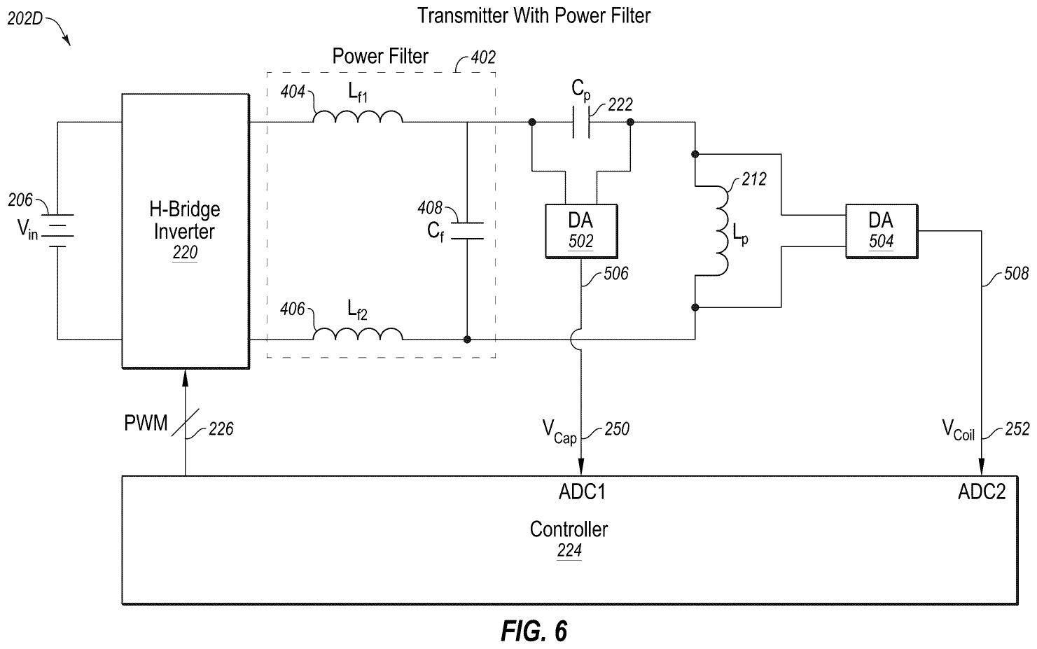

FIG. 6 is a circuit diagram of a transmitter 202D with power filter 402, according to one or more examples. Transmitter 202D of FIG. 6 is the same as the transmitter of FIG. 3 but includes power filter 402, as described in relation to FIG. 4. Transmitter 202D of FIG. 6 may be used as transmitter 202 of FIG. 2.

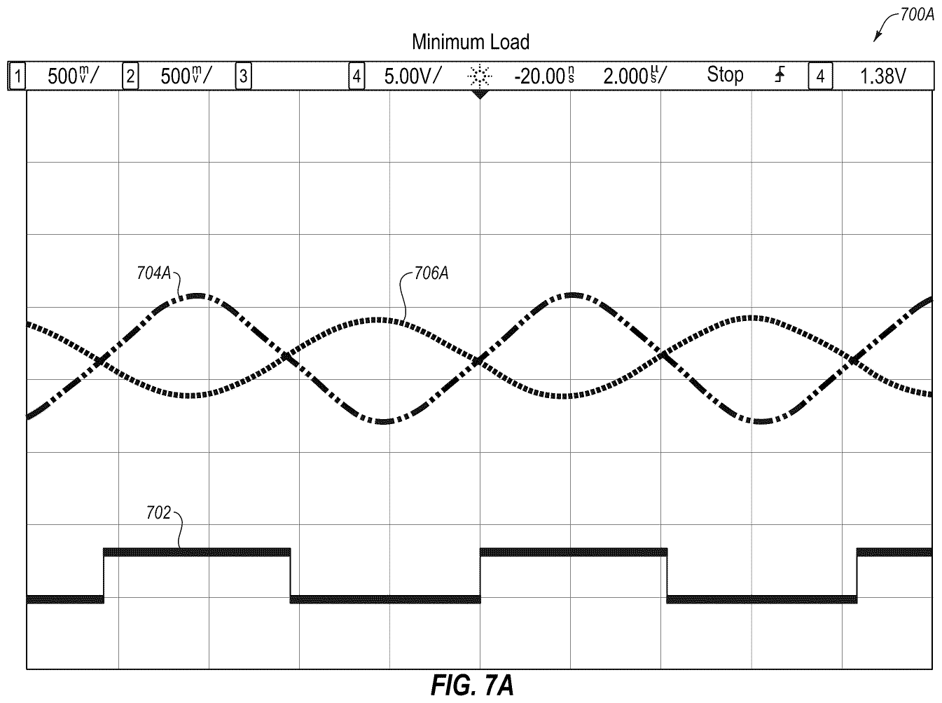

FIGS. 7A, 7B, and 7C are respective plots 700A, 700B, and 700C of the capacitor and coil voltage waveforms associated with a receiver under various load conditions. In respective plots 700A, 700B, 700C, the y-axis represents voltage potential and the x-axis represents time.

Plot 700A of FIG. 7A depicts coil and capacitor voltage potential waveforms 704A and 706A, respectively, at a minimum load (0.75 W) on the receiver. A PWM signal 702 is also shown in relation to the coil and capacitor voltage potential waveforms 704A and 706A. Note that the two capacitor voltage potential waveforms 704A and 706A are nearly out-of-phase (i.e., a 180 degree phase angle) with each other. Here, the derivative of the capacitor voltage would produce a 90-degree phase angle, causing a large reactive power circulating in the LC components of the resonant tank circuit. The active power in this condition is close to zero (0), as the current and voltage across the coil would exhibit a 90 degree phase angle.

Plot 700B of FIG. 7B depicts coil and capacitor voltage potential waveforms 704B and 706B, respectively, at a medium load (7.5 W) on the receiver. The medium load is about 50% of the rated load on the receiver. PWM signal 702 is also shown in relation to the coil and capacitor voltage potential waveforms 704B and 706B. Note that the phase angle of capacitor voltage potential waveforms 704B and 706B is less than 180 degrees, as observed in the “no load” or minimum load case. This causes a phase angle of about 60 degrees between coil voltage and coil current, and active power is supplied to the load. There is still a large circulating current resulting in the reactive power, which is not supplied to the load.

Plot 700C of FIG. 7C depicts coil and capacitor voltage potential waveforms 704C and 706C, respectively, at a full load (15 W). PWM signal 702 is also shown in relation to the coil and capacitor voltage potential waveforms 704B and 706B. Note that the phase angle between capacitor voltage potential waveforms 704C and 706C has been reduced (e.g., relative to the phase angle of waveforms of FIGS. 7A and 7B), and the amplitude of capacitor voltage potential waveforms 704C and 706C has increased (e.g., relative to the amplitudes of FIGS. 7A and 7B). This causes increased active power being supplied to the load. The phase angle between the coil voltage and current drops further down to about 45 degrees. Note that, in general, the maximum power is transferred when the phase angle between the coil voltage and current is zero (0). In theory, the phase angle between the coil voltage and current is zero can be zero (0) when the load is solely resistive. This is not a practicable possibility, however, as the receiver is utilizing an inductive-resistive (LR) load.

According one or more examples of the disclosure, the transmitter and the receiver of the wireless power system each comprise a resonant LC tank circuit including at least an inductive coil (e.g., “L”) and a capacitor (e.g., “C”). The tank circuit of the transmitter couples energy to the tank circuit of the receiver. Depending on the coupling factor, a portion of transmitter coil energy is transferred to the receiver coil. At a given input voltage and frequency, energy in the tank circuit includes two (2) portions: (1) an active energy portion, which is predominantly supplied to the receiver; and (2) a reactive energy portion, which oscillates between the tank components L and C.

If the coupling between coils is reduced (e.g., with all other conditions being fixed), the load voltage on the receiver is reduced. Given the control loop of the wireless power system, the transmitter attempts to increase the voltage to maintain the receiver voltage. When this occurs, the active power delivered to the transmitter remains same while the apparent power (which is based on the vector sum of active and reactive power) increases due to the increased input voltage. The ratio of active power to apparent power is known as power factor. The power factor reduces when the coupling decreases due to the increased apparent power. In one or more examples, the power factor may be used for detecting receiver displacement of the receiver.

Power factor variation in response to the presence of a foreign object should be understood before using the power factor for receiver displacement detection. When a foreign object is inserted between the transmitter and the receiver (without moving the receiver), the control voltage increases since part of the energy transmitted by the transmitter coil is consumed by the foreign object. Since the foreign object consumes active power, the increased input voltage supplies the active power for the foreign object as well as the receiver. This leads to an increased power factor, which is completely opposite to the behavior observed in relation to receiver displacement. Hence, these two conditions can be unambiguously detected. In one or more examples, the transmitter should indeed detect misalignment without ambiguity (e.g., foreign object presence or higher receiver power delivery may result in similar operating conditions).

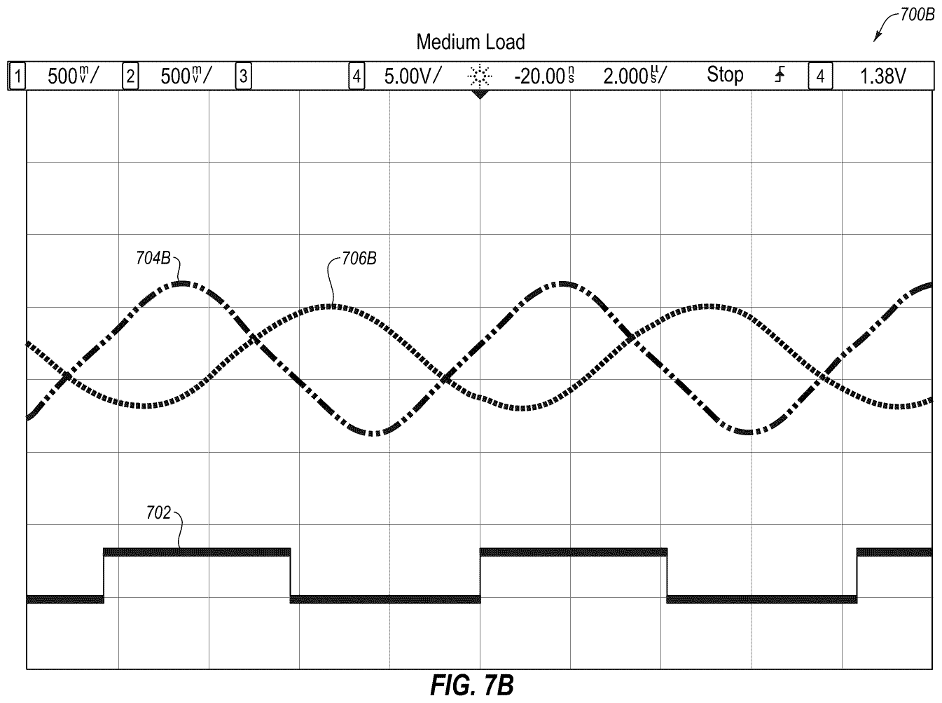

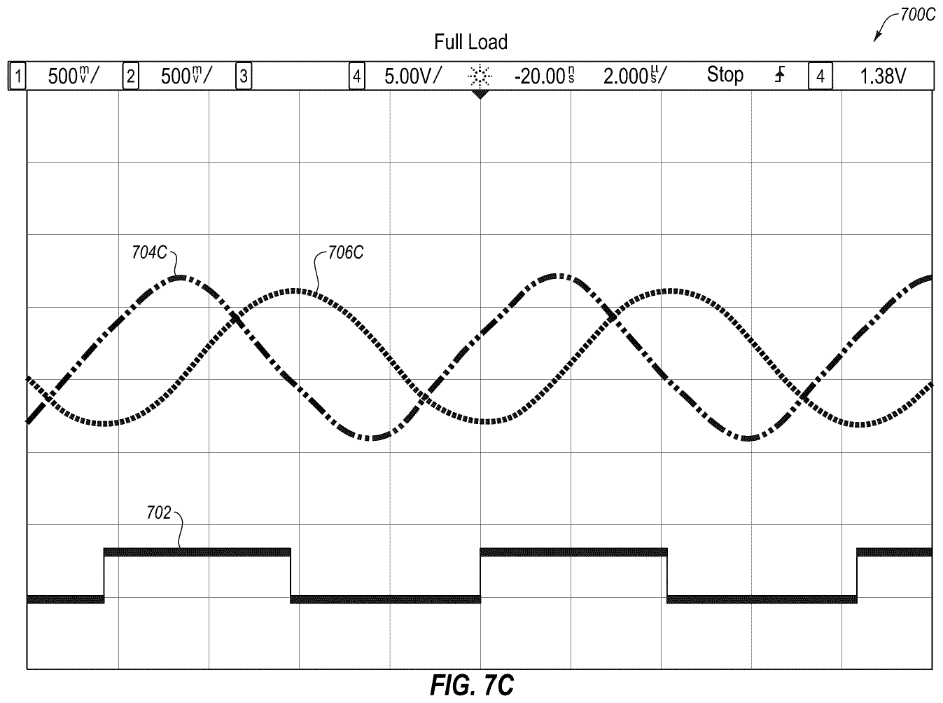

In one or more examples, the methods described herein may be performed by a controller (e.g., a microcontroller, such as a dsPIC microcontroller, without limitation) of a transmitter of a wireless power system. In the methods, extensive data computation may be performed. Since data is sampled at a very high frequency, a direct memory access (DMA) module may be used to sample and store data independently of the processor's computational power. Thus, in one or more examples, the methods of FIGS. 8-9 may be performed by a controller with use of one or more DMA modules.

FIG. 8 is a flowchart of a method 800 of performing a DMA initialization associated with a DMA module, according to one or more examples. Beginning at a start block 802 of FIG. 8, at an act 804, two (2) DMA channels are set for coil voltage and capacitor voltage, respectively. At an act 806, two (2) DMA inputs are selected and associated with respective ADC channels for coil voltage V_{coil} and capacitor voltage V_{cap}. At an act 808, the same DMA trigger is set for both coil voltage and capacitor voltage. That is, both of the DMA channels are triggered by the same trigger source (e.g., a software trigger source). At an act 810, buffers are assigned to respective DMA channels for storing sampled data. In one or more examples, respective buffer sizes of the buffers may vary from a single cycle of size twenty (20), to up to ten (10) cycles of size two-hundred (200). The flowchart of FIG. 8 ends at an end block 812.

FIG. 9 is a flowchart of a method 900 of performing a data acquisition process associated with a DMA module, according to one or more examples. In one or more examples, the data acquisition process may be a background process, for example, a background DMA data acquisition process. In one or more examples, method 900 may be performed at least partially responsive to a triggering (e.g., a software triggering) of a DMA channel. Beginning at a start block 902 of FIG. 9, at an act 904, a pointer is set to zero (0). At an act 906, a coil voltage V_{coil} and a capacitor voltage V_{cap} are sampled via the two DMA or ADC channels, respectively. At an act 908, a pointer is then incremented. As tested at an act 910, if the buffer of the DMA channel is not yet full, acts 906 and 908 are repeated. The DMA module continuously triggers the ADC channels for coil voltage V_{coil} and capacitor voltage V_{cap} until the buffer is full. When the buffer is full, the flowchart of FIG. 9 ends at an end block 912. In one or more examples, the DMA module generates an interrupt for an interrupt service routine (ISR) for processing when the buffer is full.

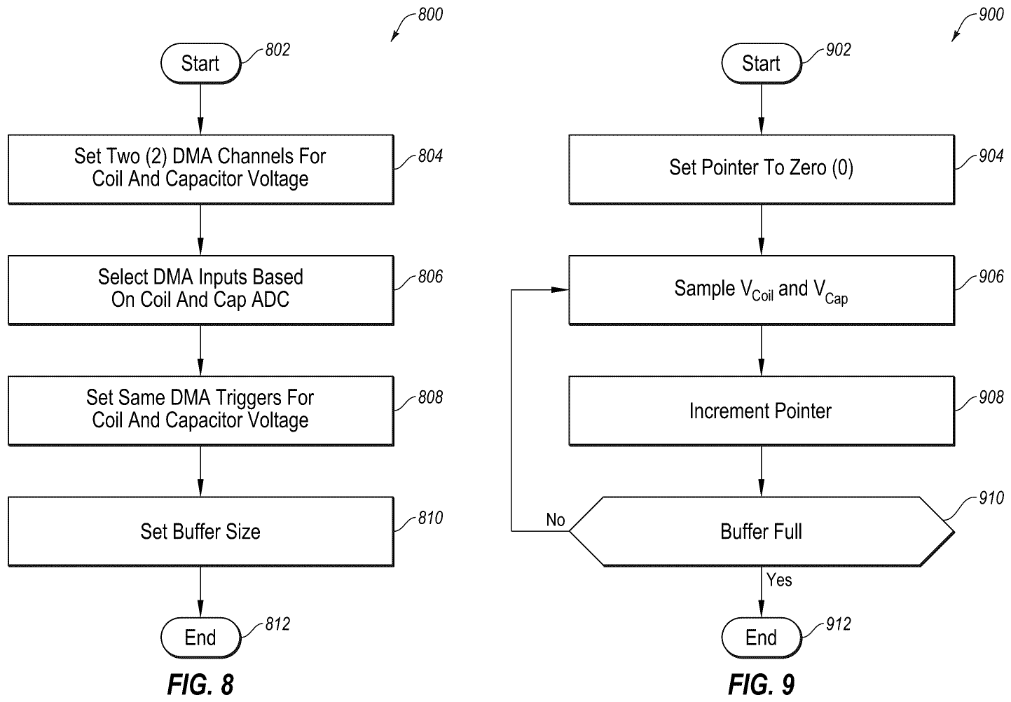

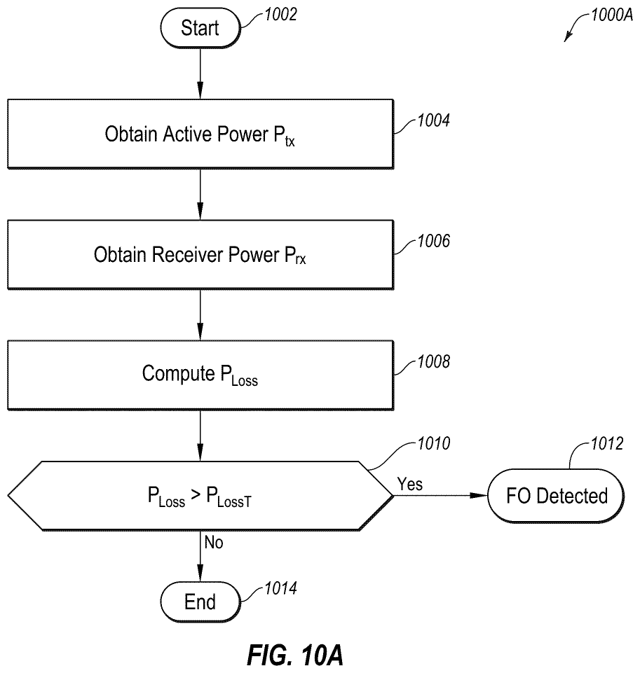

FIG. 10A is a flowchart of a method 1000A of performing power loss calculations (e.g., for foreign object interference detection), according to one or more examples. Method 1000A may be performed at a transmitter and/or a controller of the transmitter of a wireless power system.

Beginning at a start block 1002 of FIG. 10A, at an act 1004, an active power Pₜₓ of the wireless power transfer is obtained. At an act 1006, a receiver power Pᵣₓ of the wireless power transfer is obtained. At an act 1008, a power loss P_{Loss} of the wireless power transfer is computed. In one or more examples, the power loss P_{Loss} is at least partially determined based on a difference between the active power and the receiver power. At an act 1010, the power loss P_{Loss} is compared to a power loss threshold value P_{LossT}. At an act 1012, foreign object interference is detected if the power loss P_{Loss} is greater than the power loss threshold value P_{LossT}. Otherwise, foreign object interference is not detected, and the flowchart of FIG. 10A ends at an end block 1014.

Thus, in one or more examples of foreign object interference detection (i.e., without consideration of receiver displacement detection), the transmitter may compute the difference between the power transmitted and the power received by the receiver. A power loss between the transmitter and the receiver may be computed at least partially based on the difference. If the power loss exceeds a predetermined threshold value, it may be determined that foreign object interference is present. In one or more specific examples, an estimate for the transmitter power may be computed every millisecond, when the receiver is placed on the transmitter and the transmitter proceeds to transfer power. Once the power supplied to the receiver is known at a given instant, the power loss may be computed by subtracting the receiver power number shared by the receiver at the same instant. The power loss number is compared with a predetermined threshold value to determine whether foreign object interference is present. When there is foreign object interference, the power loss number may be large in comparison to the power loss number without the foreign object interference, because as the transmitter supplies its own loss, the receiver and the foreign object also contribute additional losses. When foreign object interference is detected, the transmitter operates to stop or terminate the supplying of power to the receiver to avoid heating the foreign object and wasting power.

FIG. 10B is a flowchart of a method 1000B of performing power computations associated with displaced receiver detection, according to one or more examples. Method 1000B may be performed at a transmitter and/or a controller of the transmitter of a wireless power system. In one or more examples, method 1000B may be an ISR described in relation to FIG. 9. In one or more examples, the data stored by the DMA module is worked on a sample-by-sample basis to compute the active power according to the following.

Beginning at a start block 1020 of FIG. 10B, at an act 1022, a coil current I_{coil} is computed based on capacitor voltage V_{cap}. At an act 1024, a coil voltage V_{coil} is computed for compensation of delay. At an act 1026, an active power Pₜₓ (e.g., the coil power) is computed based on the coil current I_{coil} and the coil voltage V_{coil}. At an act 1028, an apparent power (Pₐₚₚ) is computed. At an act 1030, a reactive power P_{reactive} is computed (optional). At an act 1032, a power factor (PF) is computed. At an act 1034, one or more averages for one or more of the above (e.g., active power Pₜₓ) are then computed over a time period (e.g., every 1 ms, without limitation). The flowchart of FIG. 10B ends at an end block 1036.

Additional details are now provided with respect to the above computations. At act 1022, the coil current may be calculated at every sample, except the first one. The coil current may be computed or derived based on differentiating the capacitor voltage according to the expression

$$Icoil = c * \frac{dVcap}{dt} ,$$

the digital equivalent of which is

$$Icoil = C * \frac{Vcap [ i ] - Vcap [ i - 1 ]}{Tsamp} ,$$

where C is the value of capacitor V_{cap} in Farads (F) and Tₛₐₘₚ is the sampling time in seconds. If the sampling period is fixed, the value of C/Tₛₐₘₚ may be pre-computed and provided as a constant.

As the coil current is computed at every sample except the first, the computation of the coil current will have a delay at every sample. To compensate for this delay, an averaging operation is performed on the coil voltage such that the instances of the I_{coil} and V_{coil} are identical with respect to time. Here, an average of the coil voltage may be computed or derived based on the expression

$$Vcoil\_a = \frac{Vcoil [ i ] + Vcoil [ i - 1 ]}{2} .$$

Accordingly, in one or more examples, the averaging operation is provided to ensure an accurate power computation.

At act 1022, active power Pₜₓ may be computed based on the product of coil current I_{coil} and coil voltage V_{coil}. More specifically, in one or more examples, the active power is computed over the entire interval by the dot product of the averaged V_{coil_a} and I_{coil}. More specifically, the dot product may generally be a scalar computation given by the expression

$$Ptx = {\sum }_{i = 0}^{t = N - 1} Vcoil\_a [ i ] * Icoil [ i ] .$$

The apparent power Pₐₚₚ may be computed or derived based on the product of the root-mean-square (RMS) of the coil voltage and the RMS of coil current, according to the expression

$$Papp = {Vtx}_{rms} * Itx\_rms ,$$

where the individual RMS values of the coil voltage and coil current may be computed based on the expressions

$$Vtx\_rms = \frac{\sqrt{{\sum }_{i = 0}^{i = N - 1} Vcoil\_a [ i ] * Vcoil\_a [ i ]}}{N}$$

$$and$$

$$Itx\_rms = \frac{\sqrt{{\sum }_{i = 0}^{i = N - 1} Icoil [ i ] * Icoil [ i ]}}{N} .$$

In one or more examples, reactive power P_{reactive} may be computed based on apparent power Pₐₚₚ and active power Pₜₓ. More particularly, reactive power P_{reactive} may be computed based on the square root of the difference between the square of apparent power Pₐₚₚ and the square of active power Pₜₓ. In one or more examples, reactive power P_{reactive} may be computed based on the following expression,

$$Preactive = \sqrt{{Papp}^{2} - {Ptx}^{2}} .$$

The power factor (PF) may be computed based on the ratio of active power Pₜₓ over apparent power Pₐₚₚ. In one or more examples, the power factor may be computed according to the expression,

$$PF = \frac{Ptx}{Papp} .$$

Regarding the detection of receiver displacement, when the receiver slides from an intended rest position (e.g., the center) of the transmitter, the coupling factor decreases. This causes the receiver to receive less power from the transmitter for the same operating condition. The transmitter observes an increase in the apparent power and the reactive power while the active power remains constant (or decreases only slightly). Under this condition, the power factor of the transmitter decreases as the angle between the coil voltage and the coil current increases (e.g., discussion in relation to FIGS. 7A-7C). In one or more examples, the transmitter may have a limit associated with the power factor, which, when reached, will cause the transmitter to increase the operating frequency and check for a reduction in apparent power.

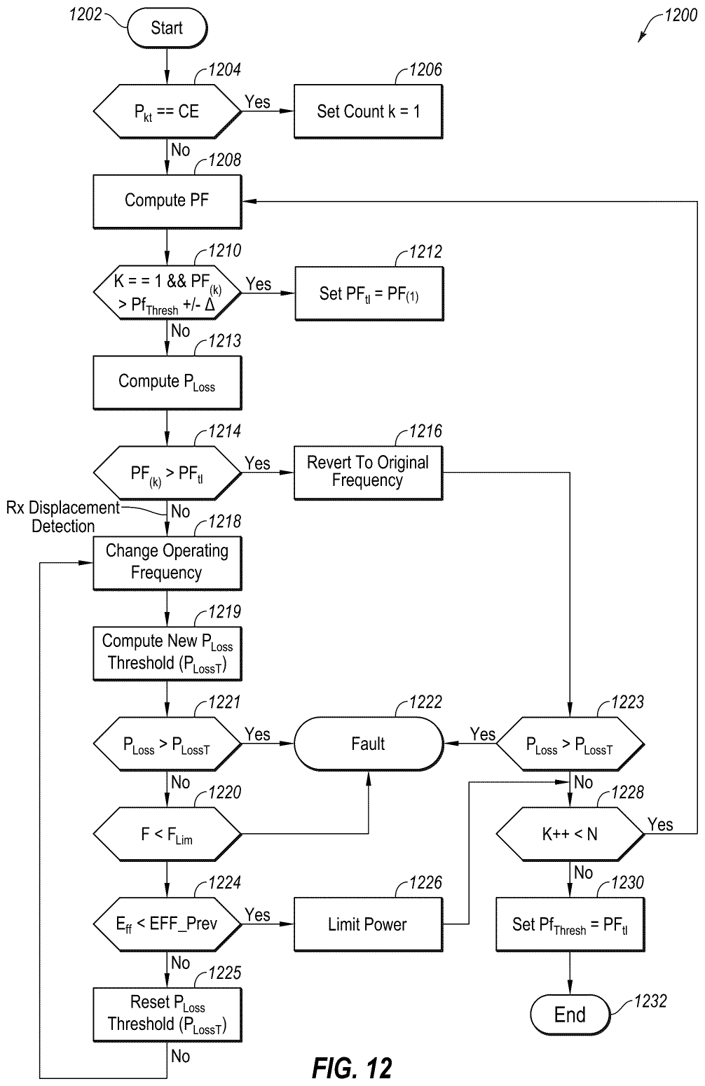

Computations may be performed regularly or periodically between control error packets sent by the receiver to adjust the active power, so that the control loop does not influence the power levels. An example timeline of such events and actions is shown and described later in relation to FIG. 13. Control error packets typically arrive in about 250 ms intervals, for example, and therefore the transmitter can gauge the extent of any receiver slide before the next packet arrives. If the transmitter is close to its maximum voltage or current limit, it can reduce the power transmitted. On the other hand, active power computation is primarily used for power loss computations and should be made available on a one (1) millisecond basis. In one or more examples, the power factor or apparent power need not be computed every millisecond like the active power computation; for example, displaced receiver detection may be performed at a slower rate, for example, around 25 ms. This would provide about ten (10) estimates between the control error packets for detection and corrective action.

The threshold used for assessment of the power factor may be constant or fixed, or alternatively, the threshold may be determined (e.g., dynamically) at the beginning of wireless transfer operation (e.g., when the receiver is placed on the transmitter). On the other hand, the limits for the coil voltage and coil current should be constant or fixed, set according to one or more known conditions or constraints (e.g., based on temperature conditions or maximum levels).

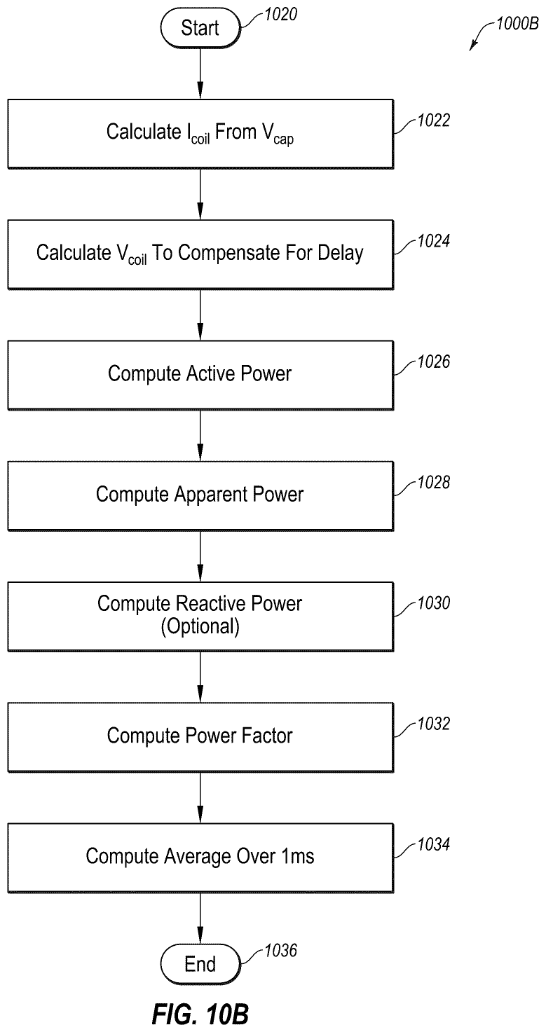

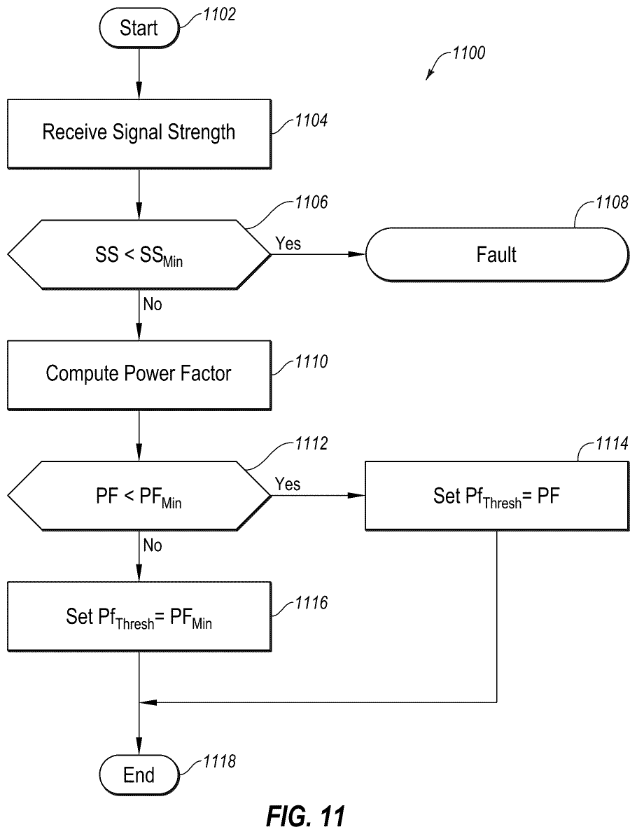

FIG. 11 is a flowchart of a method 1100 of initializing or setting a threshold for assessment of a power factor (PF) associated with wireless power transfer, according to one or more examples. Method 1100 may be performed at a transmitter and/or a controller of the transmitter of a wireless power system. The threshold may be the power factor threshold PFₜₕᵣₑₛₕ for use in method 1200 of FIG. 12.

Beginning at a start block 1102 (e.g., when the receiver is placed on the transmitter), at an act 1104, a signal strength (SS) is obtained from the receiver (e.g., one or indications sent by the receiver in a packet). At an act 1106, the signal strength is compared to a minimum signal strength threshold (e.g., SS<SSₘᵢₙ). At an act 1108, a fault condition is determined to exist at least partially responsive to identifying that the signal strength is less than the minimum signal strength threshold at act 1106. At an act 1110, the power factor PF is calculated at least partially respective to identifying that the signal strength is greater than the minimum signal strength threshold. At an act 1112, the power factor PF is compared to a minimum power factor threshold (e.g., PF>PFₘᵢₙ). At an act 1114, a power factor threshold PFₜₕᵣₑₛₕ is set to the power factor PF at least partially responsive to identifying that the power factor PF is greater than the minimum power factor threshold PFₘᵢₙ. At an act 1116, the power factor threshold PFₜₕᵣₑₛₕ is set to a minimum power factor value at least partially responsive to identifying that the power factor PF is less than or equal to the minimum power factor threshold PFₘᵢₙ. The flowchart of FIG. 11 ends at an end block 1118.

In method 1100 of FIG. 11, when the receiver is first placed on the transmitter, the transmitter receives the signal strength packet sent by the receiver. The signal strength value is directly proportional to the coupling between transmitter and receiver. The transmitter starts computing the power factor once the state machine proceeds to the power transfer phase. For a cellphone, the power is maximum at the beginning and reduces over time. The transmitter may set this power factor number as the threshold if it is greater than the minimum absolute power factor. If the signal strength value is not optimal (e.g., when the receiver is placed out-of-alignment relative to the intended rest position), the transmitter may decide on whether power is to be supplied or a fault is to be initiated.

FIG. 12 is a flowchart of a method 1200 of performing computations and computational assessments associated with displaced receiver conditions at a transmitter, according to one or more examples. Method 1200 may include a method of detecting a displaced receiver condition at a transmitter (e.g., a displacement of the receiver relative to a predetermined charging position of the transmitter), according to one or more examples. Method 1200 may be performed at a transmitter and/or a controller of the transmitter of a wireless power system.

In one or more examples, the algorithm in method 1200 of FIG. 12 executes N times (e.g., for counter k=1 to N) at regular intervals between control error packets (e.g., execution at 25 ms intervals, with control error packets being received every ˜250 ms, and N=10) (e.g., FIG. 13). When a control error packet is received, the counter k is reset to 1. The power factor PF is measured in each execution.

Beginning at a start block 1202 of FIG. 12, at an act 1204, a packet is received and examined to determine whether it is a control error (CE) packet. If the received packet is determined to be a control error packet, at an act 1206, a counter “k” is reset to one (1). If the received packet is determined not to be a control error packet, then at an act 1208 a power factor (PF) associated with the wireless power transfer is computed. At an act 1210, it is tested whether (k==1) && (PF(k)>PFₜₕᵣₑₛₕ+/−Δ). Note that “==” is an equality operator, which compares two values to determine if they are equal (“true” is returned if the values are equal and “false” is returned if the values are not equal) and “&&” is a logical AND operator. If yes at act 1210, then at an act 1212 a local PF threshold PFₜₗ is set to PF(1). If no at act 1210, then at an act 1213 the power loss P_{Loss} is computed.

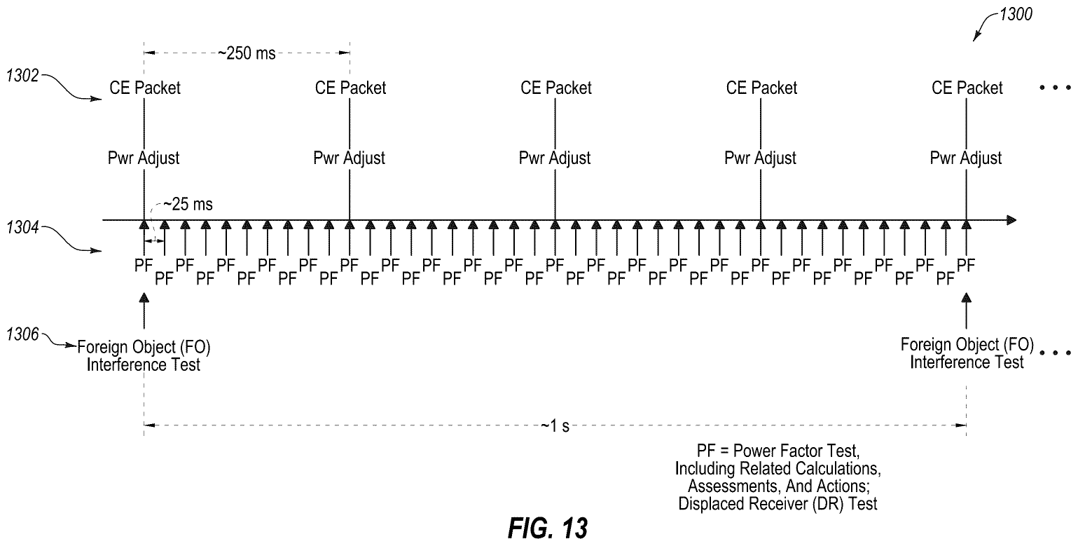

At an act 1214 it is tested whether PF(k)>PFₜₗ. If no at act 1214, then receiver displacement of the receiver is detected (i.e., detected based on decrease in the power factor, below a power factor threshold). At an act 1218, the operating frequency F is changed (e.g., stepwise toward a resonant frequency). At an act 1219, the power loss threshold P_{LossT} is then re-computed. In one or more examples, the power loss threshold P_{LossT} is re-computed based on levels associated with the newly-detected conditions. In one or more examples, the power loss threshold P_{LossT} is re-computed based on techniques described later in relation to FIG. 14.

At an act 1221, it is tested whether the power loss P_{Loss} is greater than the power loss threshold P_{LossT} (i.e., the newly computed P_{LossT}). If yes at act 1221, then at an act 1222 a fault condition is determined to exist. If no at act 1221, then at an act 1220, it is tested whether the operating frequency F<Fₗᵢₘ. If yes at act 1220, then at act 1222 the fault condition is determined to exist.

If no at act 1220, at an act 1224, it is tested whether an efficiency Eff of the wireless power transfer is less than a previous efficiency EFF_prev of the wireless power transfer (i.e., Eff<EFF_prev). If no at act 1224, then the process is to reset the power loss threshold P_{LossT} as indicated at an act 1225, repeating back to act 1218 to change the operating frequency F, and so on. If yes at act 1224, then at an act 1226 the changed operating frequency is accepted and the power level is limited.

If yes at act 1214 (i.e., no detection of receiver displacement), then at an act 1216 the operating frequency is reverted back to the original operating frequency. After act 1216, at an act 1223, it is tested whether P_{Loss}>P_{LossT}. If yes at act 1223, at act 1222 a fault condition is determined to exist. If no at act 1223, or after act 1226, processing proceeds to an act 1228 to test whether k++<N (e.g., where N=10) at act 1228. If yes at act 1228, then the process repeats back to act 1208 to again compute the power factor PF. If no at act 1228, then at an act 1230 the power factor threshold PFₜₕᵣₑₛₕ is set to the local power factor threshold PFₜₗ. The flowchart of FIG. 12 ends at an end block 1232.

Thus, during execution of method 1200 of FIG. 12, the power factor PF is compared with PFₜₕᵣₑₛₕ±Δ; if the power factor PF is within the limits, then the local power factor threshold PFₗₜ is assigned the value of the power factor PF. This value forms the basis for comparing the power factor values computed in subsequent steps between packets. The input voltage is changed after receiving the control error packet, and the next change occurs after the next control error packet. When a CE=0 packet is received, the steady operating point is reached (e.g., within 20 ms), and (practically) the power transferred to the receiver is fixed until next control error packet. Under these conditions, any reduction in the power factor is caused only by a receiver slide or displacement.

In the computations and assessments of method 1200 of FIG. 12, the power factor may be replaced with apparent power if a higher resolution is desired (for example, the apparent power may be compared with an apparent power threshold, and detecting the apparent power to be greater than the apparent power threshold indicates receiver displacement). If the receiver slides from its initial position, the power factor will be reduced (Pₐₚₚ will increase); and if it is less than the local power factor threshold PFₗₜ, the transmitter may attempt to change the frequency (e.g., in a variable-voltage topology). The change is limited to a frequency limit that is determined in accordance with the topology, and a fault is detected if the limit is reached. If the frequency change leads to an improved efficiency, the new frequency is retained as the operating frequency. If the receiver slides back toward the center of the transmitter, the power factor will improve, and the frequency may be reverted back to the original frequency. If the efficiency measurement is not available, the apparent power may be used as an indicator to indicate the improving operating condition. The apparent power will reduce when the new operating frequency leads to a better operating point.

FIG. 13 is an example timeline 1300 of events and actions associated with the methods described in relation to FIGS. 10A-10B, 11, and 12. A number of CE packets 1302 are indicated along a top of timeline 1300 (e.g., respective ones of CE packets 1302 are at ˜250 ms intervals). A number of FO interference tests 1306 are indicated near a bottom of timeline 1300 (e.g., respective ones of FO interference tests 1306 are at ˜1 second intervals, or once every four (4) CE packets). A number of power factor (PF) related tests 1304 are indicated along a middle of timeline 1300 (e.g., respective ones of PF related tests 1304 are at ˜25 ms intervals, or occurring ten (10) times between each pair of CE packets). PF related tests 1304 are associated with power factor related computations, assessments, and actions, including displaced receiver (DR) check and detection (e.g., FIG. 12). In one or more examples, the active power for power loss computations may be made available on a one (1) millisecond basis (not indicated in FIG. 13).

FIG. 14 is a plot 1400 of a function or relation of power loss threshold ratios (y-axis) versus power level ratios (x-axis), according to one or more examples. The function or relation of plot 1400 of FIG. 14 is an illustrative example of power loss threshold variation over transmitter operation. In one or more examples, the function or relation of plot 1400 may be used for computing and re-computing a power loss threshold for transmitter operation (e.g., the computing and re-computing of the power loss threshold P_{LossT} in act 1219 of method 1200 of FIG. 12).

In one or more examples of FIG. 14, respective ones of the power level ratios (x-axis) are ratios of power levels after detection of receiver displacement over respective power levels before the receiver displacement. Respective ones of the power loss threshold ratios (y-axis) are ratios of power loss thresholds after detection of receiver displacement over respective power loss thresholds before the receiver displacement.

Depending on the power level of operation at a given point, the power loss threshold may be changed in response to detection of receiver displacement. The change in the power loss threshold is a function of the current power level at which the transmitter is operating after detection of receiver displacement and the power level before the receiver displacement (i.e., current power level with receiver displacement/power level before the receiver displacement). On the other hand, the y-axis of plot 1400 has ratios of power loss thresholds after detection of receiver displacement and power loss thresholds before the receiver displacement (i.e., power loss threshold with receiver displacement/power loss threshold before the receiver displacement).

In one or more examples, the function or relation of plot 1400 may be stored in memory of the transmitter as either multiple parameters that represent a mathematical expression of the relation or as data values in a table. In one or more examples, a new power loss threshold (i.e., a new power loss threshold after detection of receiver displacement) may be computed, determined, or selected at least partially based on the function or relation between the power loss threshold ratios and the power level ratios using a current power level ratio (i.e., current power level with receiver displacement/power level before the receiver displacement) as an input.

As described herein according to one or more examples, a low-cost solution is provided for detecting movement of the receiver relative to the transmitter. Using samples of coil voltage and capacitor voltage acquired via a differential amplifier circuit, the active power, the apparent power, and the power factor may be accurately computed. In one or more examples, the active power and the power factor will increase if a foreign object is placed between the transmitter and the receiver, while the active power will increase (or stay the same) and power factor will decrease when the receiver slides away from the transmitter.

In one or more examples, the power factor threshold is set at the beginning when the receiver is placed on the transmitter. The threshold is the minimum of PFₘᵢₙ and measured PF. This accommodates the condition when the receiver is placed away from the center of the transmitter. When the receiver slides outside of a limit, the transmitter attempts to change the operating point. If efficiency is very low, the transmitter limits the power.

In one or more examples, the power may be averaged to obtain the active transmitted power. The apparent power Pₐₚₚ may be computed as product of V_{coil} and I_{coil} RMS values. The power factor may be computed as a ratio of Pₜₓ/Pₐₚₚ. PFₘᵢₙ may be set according to design configuration based on the maximum coil voltage and current. When the receiver is placed on the transmitter, PFₜₕᵣₑₛₕ may be set as one of the measured PF or minimum PFₘᵢₙ. During wireless power transfer, the PF is calculated periodically (˜25 ms) and checked against PFₜₕᵣₑₛₕ for misalignment. In one or more examples, when misalignment is detected due to sliding, the transmitter may attempt to change the operating point by increasing the frequency in a variable control voltage topology. If there is improvement in efficiency, the transmitter continues to operate at this frequency. If the efficiency does not improve, the power is limited so that currents and voltages are within limits. If there is excessive receiver slide and the power supplied is very low, the transmitter disconnects power and indicates fault to bring it to the attention of the user.

Advantages of one or more examples of the methods, apparatuses, and systems of the disclosure may include:
1. Accurate computations for detection of displacement of the receiver.
2. Improved efficiency under non-ideal conditions.
3. Limits to the power to the receiver under deteriorated conditions.
4. Simple implementation including low-cost hardware.
5. Alternative circuitry to coil current sensing circuitry of the transmitter (e.g., no current sensor needed for measuring coil current).

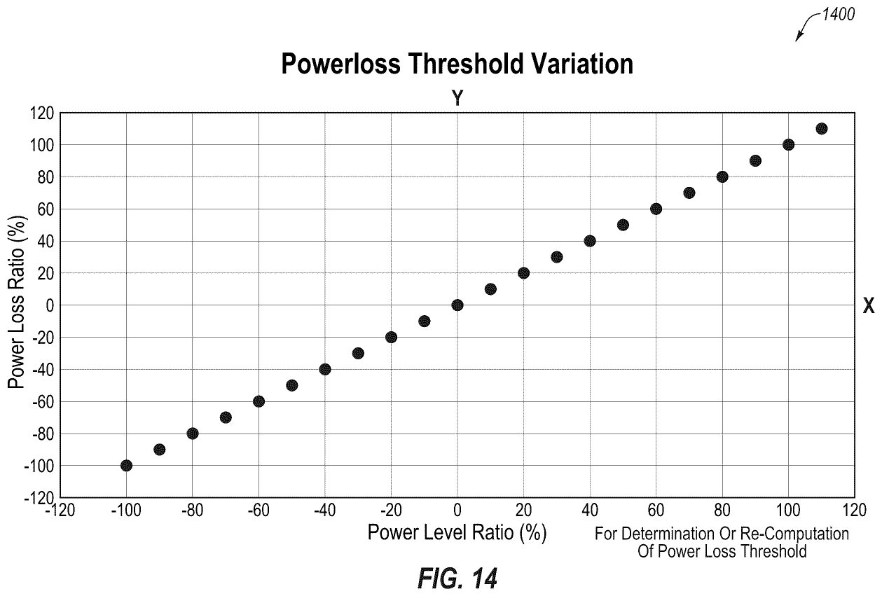

FIG. 15 is a flowchart of a method 1500 of controlling operation of a transmitter for wireless power transfer, according to one or more examples. Method 1500 may include an act of detecting a displaced receiver condition at a transmitter (e.g., a displacement of the receiver relative to a predetermined charging position associated with the transmitter), according to one or more examples. Method 1500 may be performed at a transmitter and/or a controller of the transmitter of a wireless power system.

Beginning at a start block 1502, at an act 1504, a wireless power signal is generated in one or more transmit coils, which inductively couple with one or more receive coils of a receiver for wireless power transfer. At an act 1506, the wireless power transfer is terminated at least partially responsive to detecting a power loss of the wireless power transfer to be greater than a power loss threshold when a power factor of the wireless power transfer is greater than a power factor threshold. At an act 1508, the transmitter refrains from terminating the wireless power transfer at least partially responsive to detecting the power factor to be less than the power factor threshold. The flowchart of FIG. 15 ends at an end block 1510.

In one or more examples of method 1500, detecting, at act 1506, that the power loss is greater than the power loss threshold when the power factor is greater than the power factor threshold is indicative of foreign object interference. In one or more examples, detecting, at act 1508, that the power factor is less than the power factor threshold is indicative of receiver displacement of the receiver (e.g., relative to a predetermined charging position associated with the transmitter).

In one or more examples of method 1500, an active power of the wireless power transfer is determined at least partially based on a product of detected coil voltage and detected coil current. A receiver power of the wireless power transfer is determined at least partially based on one or more indications communicated from the receiver. The power loss is determined at least partially based on a difference between the active power and the receiver power. In one or more examples of method 1500, an apparent power of the wireless power transfer is determined at least partially based on a product of RMS coil voltage and RMS coil current. The power factor is determined at least partially based on a ratio of the active power and the apparent power.

In one or more examples of method 1500, the power loss threshold is (e.g., initially) set to a first value. The power loss threshold is changed to a second value to at least partially responsive to detecting the power factor is less than the power factor threshold. Here, changing the power loss threshold to the second value prevents the termination of the wireless power transfer.

In one or more examples of method 1500, an operating frequency of the wireless power signal is changed at least partially responsive to detecting the power factor is less than the power factor threshold. It is determined whether an efficiency of the wireless power transfer at the changed operating frequency is increased with respect to a previous efficiency of the wireless power transfer. The changing of the operating frequency and the determining of whether the efficiency is increased is repeated (e.g., one or more times as needed) at least partially responsive to determining that the efficiency is not increased with respect to the previous efficiency. A power level of the wireless power transfer may be limited at the changed operating frequency at least partially responsive to determining that the efficiency at the changed operating frequency is increased with respect to the previous efficiency.

In one or more additional related methods, a controller of a transmitter is adapted to generate a wireless power signal in one or more transmit coils, which inductively couple with one or more receive coils of a receiver for wireless power transfer. At the controller of the transmitter, a power loss threshold is set to a first value. The power loss threshold is changed to a second value at least partially responsive to detecting a power factor of the wireless power transfer to be less than a power factor threshold. The wireless power transfer is terminated at least partially responsive to detecting a power loss of the wireless power transfer to be greater than the power loss threshold.

In one or more examples of the additional related methods, changing the power loss threshold to the second value prevents termination of the wireless power transfer. In one or more examples, changing the power loss threshold to the second value comprises changing the power loss threshold to the second value that is greater than the first value.

In one or more examples of the additional related methods, detecting that the power loss is greater than the power loss threshold when the power factor is greater than the power factor threshold is indicative of foreign object interference. In one or more examples, detecting that the power factor is less than the power factor threshold is indicative of receiver displacement of the receiver.

In one or more examples of the additional related methods, an active power of the wireless power transfer is determined at least partially based on a product of detected coil voltage and detected coil current. A receiver power of the wireless power transfer is determined at least partially based on one or more indications communicated from the receiver. The power loss is determined at least partially based on a difference between the active power and the receiver power. An apparent power of the wireless power transfer is determined at least partially based on a product of RMS coil voltage and RMS coil current. The power factor is determined at least partially based on a ratio of the active power and the apparent power.

In one or more examples of the additional related methods, changing the power loss threshold to the second value comprises changing the power loss threshold to the second value at least partially responsive to detecting the power factor to be less than the power factor threshold or an apparent power of the wireless power transfer to be greater than an apparent power threshold.

In one or more examples of the additional related methods, changing the power loss threshold to the second value comprises computing the power loss threshold at least partially based on a relation of power loss threshold ratios versus power level ratios. In one or more examples, respective ones of the power level ratios are ratios of power levels after detection of receiver displacement over respective power levels before the receiver displacement. In one or more examples, respective ones of the power loss threshold ratios are ratios of power loss thresholds after detection of receiver displacement over respective power loss thresholds before the receiver displacement.

In one or more examples of the additional related methods, an operating frequency of the wireless power signal is changed at least partially responsive to detecting the power factor is less than the power factor threshold. It is determined whether an efficiency of the wireless power transfer at the changed operating frequency is increased with respect to a previous efficiency of the wireless power transfer. The changing of the operating frequency and the determining of whether the efficiency is increased is repeated (e.g., one or more times as needed) at least partially responsive to determining that the efficiency is not increased with respect to the previous efficiency. A power level of the wireless power transfer may be limited at the changed operating frequency at least partially responsive to determining that the efficiency at the changed operating frequency is increased with respect to the previous efficiency.

In one or more alternative related methods, a wireless power signal is generated in the one or more transmit coils of the transmitter for wireless power transfer. A power factor of the wireless power transfer is determined at least partially based on a ratio of an active power of the wireless power transfer and an apparent power of the wireless power transfer. A displaced receiver condition of the receiver is determined at least partially responsive to detecting the power factor to be less than a power factor threshold.

In one or more examples of the alternative related methods, an operating frequency of the wireless power signal is changed at least partially responsive to detecting that the power factor is less than the power factor threshold. It is determined whether an efficiency of the wireless power transfer at the changed operating frequency is increased with respect to a previous efficiency of the wireless power transfer. The changing of the operating frequency and the determining of whether the efficiency is increased is repeated (e.g., one or more times as needed) at least partially responsive to determining that the efficiency is not increased with respect to the previous efficiency.

In one or more examples of the alternative related methods, a power loss of the wireless power transfer is determined at least partially based on the active power and a receiver power of the receiver. A foreign object interference condition is determined at least partially responsive to detecting the power loss to be greater than a power loss threshold when the power factor is greater than the power factor threshold. The wireless power transfer is terminated at least partially responsive to determining the foreign object interference condition.

FIG. 16A is a system 1600 for wireless power transfer or wireless charging (“wireless power system 1600”), according to one or more examples. Wireless power system 1600 includes a mobile phone charger 1602 and a mobile device 1604 (e.g., a cellphone or smart phone). Mobile phone charger 1602 includes a transmitter (i.e., a transmitter for wireless power transfer) contained in a housing. Mobile device 1604 is electrically powered by one or more batteries and includes a receiver (i.e., a receiver for wireless power transfer). Mobile device 1604 may be referred to as a battery-operated mobile device.

For wireless charging, mobile device 1604 including the receiver is positioned on a surface 1610 of mobile phone charger 1602 (e.g., on a smooth and/or unobstructed top surface of a housing or container of mobile phone charger 1602). In one or more examples, mobile device 1604 including the receiver is positioned on surface 1610 of mobile phone charger 1602 at a predetermined charging position (e.g., an intended rest position for wireless charging, such as a center of mobile phone charger 1602). Thereafter, mobile phone charger 1602 operates its transmitter to wirelessly charge the one or more batteries of mobile device 1604.

Over time, mobile device 1604 including the receiver may slide over the surface of mobile phone charger 1602 in gradual increments or sudden movements. Such displacement typically occurs in automotive applications where mobile device 1604 is moved by vehicle vibrations or movement. As depicted in FIG. 16B, mobile device 1604 including the receiver may be moved to a displaced position relative to predetermined charging position 1612 (e.g., at a distance “d” from predetermined charging position 1612 in FIG. 16B), where coupling with the transmitter is poor. For proper wireless power transfer in such an environment, mobile phone charger 1602 including the transmitter may operate according to the methods, apparatuses, and/or systems described above in relation to the figures.

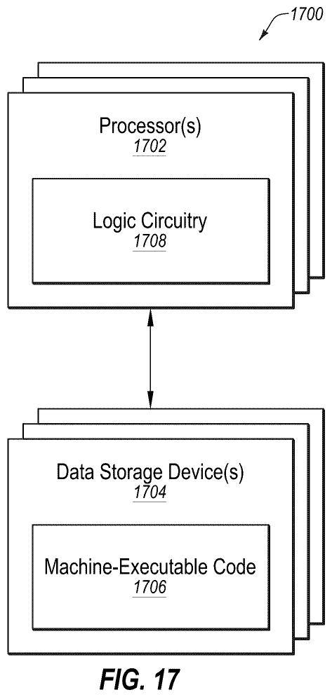

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 17 illustrates non-limiting examples of implementations of functional elements disclosed herein. In some examples, some or all portions of the functional elements disclosed herein may be performed by hardware specially implemented for carrying out the functional elements.

FIG. 17 is a block diagram of circuitry 1700 that, in some examples, may be used to implement various functions, operations, acts, processes, and/or methods disclosed herein. Circuitry 1700 includes one or more processors 1702 (sometimes referred to herein as “processors 1702”) operably coupled to one or more data storage devices (sometimes referred to herein as “storage 1704”). Storage 1704 includes machine-executable code 1706 stored thereon and processors 1702 include logic circuitry 1708. Machine-executable code 1706 includes information describing functional elements that may be implemented by (e.g., performed by) logic circuitry 1708. Logic circuitry 1708 is adapted to implement (e.g., perform) the functional elements described by machine-executable code 1706. Circuitry 1700, when executing the functional elements described by machine-executable code 1706, should be considered as special purpose hardware for carrying out functional elements disclosed herein. In some examples, processors 1702 may be to perform the functional elements described by machine-executable code 1706 sequentially, concurrently (e.g., on one or more different hardware platforms), or in one or more parallel process streams.

When implemented by logic circuitry 1708 of processors 1702, machine-executable code 1706 is to adapt processors 1702 to perform operations of examples disclosed herein. In one or more examples, machine-executable code 1706 may be to adapt processors 1702 to perform at least a portion or a totality of method 800 of FIG. 8, method 900 of FIG. 9, methods 1000A and 1000B of FIGS. 10A and 10B, method 1100 of FIG. 11, method 1200 of FIG. 12, and/or method 1500 of FIG. 15. In one or more other examples, machine-executable code 1706 may be to adapt processors 1702 to perform at least a portion or a totality of the operations discussed for the controller of FIG. 2, the controller of FIG. 5, and/or the controller of FIG. 6.

Processors 1702 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is to execute functional elements corresponding to machine-executable code 1706 (e.g., software code, firmware code, hardware descriptions) related to examples of the present disclosure. It is noted that a general-purpose processor (may also be referred to herein as a host processor or simply a host) may be a microprocessor, but in the alternative, processors 1702 may include any conventional processor, controller, microcontroller, or state machine. Processors 1702 may also be implemented as a combination of computing devices, such as a combination of a DSP and a microprocessor, a plurality of microprocessors, one or more microprocessors in conjunction with a DSP core, or any other such configuration.

In some examples, storage 1704 includes volatile data storage (e.g., random-access memory (RAM)), non-volatile data storage (e.g., Flash memory, a hard disc drive, a solid state drive, erasable programmable read-only memory (EPROM), etc.). In some examples, processors 1702 and storage 1704 may be implemented into a single device (e.g., a semiconductor device product, a system on chip (SOC), etc.). In some examples, processors 1702 and storage 1704 may be implemented as separate devices.

In some examples, machine-executable code 1706 may include computer-readable instructions (e.g., software code, firmware code). By way of non-limiting example, the computer-readable instructions may be stored by storage 1704, accessed directly by processors 1702, and executed by processors 1702 using at least logic circuitry 1708. Also by way of non-limiting example, the computer-readable instructions may be stored on storage 1704, transferred to a memory device (not shown) for execution, and executed by processors 1702 using at least logic circuitry 1708. Accordingly, in some examples, logic circuitry 1708 includes electrically configurable logic circuitry 1708.

In some examples, machine-executable code 1706 may describe hardware (e.g., circuitry) to be implemented in logic circuitry 1708 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEM VERILOG™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of logic circuitry 1708 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, machine-executable code 1706 may include an HDL, an RTL, a GL description, a mask level description, other hardware description, or any combination thereof.

In examples where machine-executable code 1706 includes a hardware description (at any level of abstraction), a system (not shown, but including storage 1704) may be to implement the hardware description described by machine-executable code 1706. By way of non-limiting example, processors 1702 may include a programmable logic device (e.g., an FPGA or a PLC) and logic circuitry 1708 may be electrically controlled to implement circuitry corresponding to the hardware description into logic circuitry 1708. Also by way of non-limiting example, logic circuitry 1708 may include hard-wired logic manufactured by a manufacturing system (not shown, but including storage 1704) according to the hardware description of machine-executable code 1706.

Regardless of whether machine-executable code 1706 includes computer-readable instructions or a hardware description, logic circuitry 1708 is adapted to perform the functional elements described by machine-executable code 1706 when implementing the functional elements of machine-executable code 1706. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, etc.) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc.

Any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

A non-exhaustive, non-limiting list of examples follows. Note that each of the examples listed below is explicitly and individually indicated as being combinable with all others of the examples listed below and examples discussed above. It is intended, however, that these examples are combinable with all other examples unless it would be apparent to one of ordinary skill in the art that the examples are not combinable.

Example 1: A method comprising: generating a wireless power signal in one or more transmit coils of a transmitter which inductively couple with one or more receive coils of a receiver for wireless power transfer; terminating the wireless power transfer at least partially responsive to detecting a power loss of the wireless power transfer to be greater than a power loss threshold when a power factor of the wireless power transfer is greater than a power factor threshold; and refraining from terminating the wireless power transfer at least partially responsive to detecting the power factor to be less than the power factor threshold.

Example 2: The method according to Example 1, wherein detecting the power loss to be greater than the power loss threshold when the power factor is greater than the power factor threshold is indicative of foreign object interference.

Example 3: The method according to any of Examples 1 and 2, wherein detecting the power factor to be less than the power factor threshold is indicative of receiver displacement of the receiver relative to a predetermined charging position associated with the transmitter.

Example 4: The method according to any of Examples 1 through 3, comprising: determining an active power of the wireless power transfer at least partially based on a product of detected coil voltage and detected coil current; determining a receiver power of the wireless power transfer at least partially based on one or more indications communicated from the receiver; and determining the power loss at least partially based on a difference between the active power and the receiver power.

Example 5: The method according to any of Examples 1 through 4, comprising: determining an apparent power of the wireless power transfer at least partially based on a product of root mean square (RMS) coil voltage and RMS coil current; and determining the power factor at least partially based on a ratio of the active power and the apparent power.

Example 6: The method according to any of Examples 1 through 5, comprising: setting the power loss threshold to a first value; and changing the power loss threshold to a second value to at least partially responsive to detecting the power factor to be less than the power factor threshold, wherein changing the power loss threshold to the second value prevents the termination of the wireless power transfer.

Example 7: The method according to any of Examples 1 through 6, comprising: changing an operating frequency of the wireless power signal at least partially responsive to detecting the power factor to be less than the power factor threshold.

Example 8: The method according to any of Examples 1 through 7, comprising: determining whether an efficiency of the wireless power transfer at the changed operating frequency is increased with respect to a previous efficiency of the wireless power transfer; and repeating the changing of the operating frequency and the determining of whether the efficiency is increased at least partially responsive to determining that the efficiency is not increased with respect to the previous efficiency.

Example 9: The method according to any of Examples 1 through 8, comprising: limiting a power level of the wireless power transfer at the changed operating frequency at least partially responsive to determining that the efficiency at the changed operating frequency is increased with respect to the previous efficiency.

Example 10: An apparatus comprising: a transmitter including: a transmitter circuitry, the transmitter circuitry including one or more transmit coils to inductively couple with one or more receive coils of a receiver; and a controller to: generate a wireless power signal in the one or more transmit coils for wireless power transfer; terminate the wireless power transfer at least partially responsive to detecting a power loss of the wireless power transfer to be greater than a power loss threshold when a power factor of the wireless power transfer is greater than a power factor threshold; and refrain from terminating the wireless power transfer at least partially responsive to detecting the power factor to be less than the power factor threshold.

Example 11: The apparatus according to Example 10, wherein detecting the power loss to be greater than the power loss threshold when the power factor is greater than the power factor threshold is indicative of foreign object interference.

Example 12: The apparatus according to any of Examples 10 and 11, wherein detecting the power factor to be less than the power factor threshold is indicative of receiver displacement of the receiver relative to a predetermined charging position associated with the transmitter.

Example 13: The apparatus according to any of Examples 10 through 12, wherein: the controller is to: determine an active power of the wireless power transfer at least partially based on a product of detected coil voltage and detected coil current; determine a receiver power of the wireless power transfer at least partially based on one or more indications communicated from the receiver; and determine the power loss at least partially based on a difference between the active power and the receiver power.

Example 14: The apparatus according to any of Examples 10 through 13, wherein: the controller is to: determine an apparent power of the wireless power transfer at least partially based on a product of root mean square (RMS) coil voltage and RMS coil current; and determine the power loss at least partially based on a ratio of the active power and the apparent power.

Example 15: A method comprising: at a controller of a transmitter adapted to generate a wireless power signal in one or more transmit coils which inductively couple with one or more receive coils of a receiver for wireless power transfer, setting a power loss threshold to a first value; changing the power loss threshold to a second value at least partially responsive to detecting a power factor of the wireless power transfer to be less than a power factor threshold; and terminating the wireless power transfer at least partially responsive to detecting a power loss of the wireless power transfer to be greater than the power loss threshold.

Example 16: The method according to Example 15, wherein changing the power loss threshold to the second value prevents termination of the wireless power transfer.

Example 17: The method according to any of Examples 15 and 16, wherein changing the power loss threshold to the second value comprises changing the power loss threshold to the second value that is greater than the first value.

Example 18: The method according to any of Examples 15 through 17, wherein detecting the power loss to be greater than the power loss threshold when the power factor is greater than the power factor threshold is indicative of foreign object interference.

Example 19: The method according to any of Examples 15 through 18, wherein detecting the power factor to be less than the power factor threshold is indicative of receiver displacement of the receiver.

Example 20: The method according to any of Examples 15 through 19, comprising: at the controller of the transmitter, determining an active power of the wireless power transfer at least partially based on a product of detected coil voltage and detected coil current; determining a receiver power of the wireless power transfer at least partially based on one or more indications communicated from the receiver; and determining the power loss at least partially based on a difference between the active power and the receiver power.

Example 21: The method according to any of Examples 15 through 20, comprising: at the controller of the transmitter, determining an apparent power of the wireless power transfer at least partially based on a product of root mean square (RMS) coil voltage and RMS coil current; and determining the power factor at least partially based on a ratio of the active power and the apparent power.

Example 22: The method according to any of Examples 15 through 21, wherein changing the power loss threshold to the second value comprises: computing the power loss threshold at least partially based on a relation of power loss threshold ratios versus power level ratios, respective ones of the power level ratios comprising ratios of power levels after detection of receiver displacement over respective power levels before the receiver displacement, respective ones of the power loss threshold ratios comprising ratios of power loss thresholds after detection of receiver displacement over respective power loss thresholds before the receiver displacement.

Example 23: The method according to any of Examples 15 through 22, wherein changing the power loss threshold to the second value comprises changing the power loss threshold to the second value at least partially responsive to detecting the power factor to be less than the power factor threshold or an apparent power of the wireless power transfer to be greater than an apparent power threshold.

Example 24: The method according to any of Examples 15 through 23, comprising: changing an operating frequency of the wireless power signal at least partially responsive to detecting the power factor to be less than the power factor threshold.

Example 25: The method according to any of Examples 15 through 24, comprising: determining whether an efficiency of the wireless power transfer at the changed operating frequency is increased with respect to a previous efficiency of the wireless power transfer; and repeating the changing of the operating frequency and the determining of whether the efficiency is increased at least partially responsive to determining that the efficiency is not increased with respect to the previous efficiency.

Example 26: The method according to any of Examples 15 through 25, comprising: limiting a power level of the wireless power transfer at the changed operating frequency at least partially responsive to determining that an efficiency at the changed operating frequency is increased with respect to a previous efficiency.

Example 27: An apparatus comprising: a transmitter including: a transmitter circuitry, the transmitter circuitry including one or more transmit coils to inductively couple with one or more receive coils of a receiver; and a controller to: generate a wireless power signal in the one or more transmit coils for wireless power transfer; determine a power factor of the wireless power transfer at least partially based on a ratio of an active power of the wireless power transfer and an apparent power of the wireless power transfer; and determine a displaced receiver condition of the receiver at least partially responsive to detecting the power factor to be less than a power factor threshold.

Example 28: The apparatus according to Example 27, wherein: the controller is to: change an operating frequency of the wireless power signal at least partially responsive to determining the displaced receiver condition.

Example 29: The apparatus according to any of Examples 27 and 28, wherein: the controller is to: determine whether an efficiency of the wireless power transfer at the changed operating frequency is increased with respect to a previous efficiency of the wireless power transfer; and repeat the changing of the operating frequency and the determining of whether the efficiency is increased at least partially responsive to determining that the efficiency is not increased with respect to the previous efficiency.

Example 30: The apparatus according to any of Examples 27 through 29, wherein: the controller is to: determine a power loss of the wireless power transfer at least partially based on the active power and a receiver power of the receiver; determine a foreign object interference condition at least partially responsive to detecting the power loss to be greater than a power loss threshold when the power factor is greater than the power factor threshold; and terminate the wireless power transfer at least partially responsive to determining the foreign object interference condition.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A method comprising:
generating a wireless power signal in one or more transmit coils of a transmitter which inductively couple with one or more receive coils of a receiver for wireless power transfer;
terminating the wireless power transfer at least partially responsive to detecting a power loss of the wireless power transfer to be greater than a power loss threshold when a power factor of the wireless power transfer is greater than a power factor threshold; and
refraining from terminating the wireless power transfer at least partially responsive to detecting the power factor to be less than the power factor threshold.

2. The method of claim 1, wherein detecting the power loss to be greater than the power loss threshold when the power factor is greater than the power factor threshold is indicative of foreign object interference.

3. The method of claim 2, wherein detecting the power factor to be less than the power factor threshold is indicative of receiver displacement of the receiver relative to a predetermined charging position associated with the transmitter.

4. The method of claim 1, comprising:
determining an active power of the wireless power transfer at least partially based on a product of detected coil voltage and detected coil current;
determining a receiver power of the wireless power transfer at least partially based on one or more indications communicated from the receiver; and
determining the power loss at least partially based on a difference between the active power and the receiver power.

5. The method of claim 4, comprising:
determining an apparent power of the wireless power transfer at least partially based on a product of root mean square (RMS) coil voltage and RMS coil current; and
determining the power factor at least partially based on a ratio of the active power and the apparent power.

6. The method of claim 1, comprising:
setting the power loss threshold to a first value; and
changing the power loss threshold to a second value to at least partially responsive to detecting the power factor to be less than the power factor threshold,
wherein changing the power loss threshold to the second value prevents the termination of the wireless power transfer.

7. The method of claim 1, comprising:
changing an operating frequency of the wireless power signal at least partially responsive to detecting the power factor to be less than the power factor threshold.

8. The method of claim 7, comprising:
determining whether an efficiency of the wireless power transfer at the changed operating frequency is increased with respect to a previous efficiency of the wireless power transfer; and
repeating the changing of the operating frequency and the determining of whether the efficiency is increased at least partially responsive to determining that the efficiency is not increased with respect to the previous efficiency.

9. The method of claim 8, comprising:
limiting a power level of the wireless power transfer at the changed operating frequency at least partially responsive to determining that the efficiency at the changed operating frequency is increased with respect to the previous efficiency.

10. An apparatus comprising:
a transmitter including:
a transmitter circuitry, the transmitter circuitry including one or more transmit coils to inductively couple with one or more receive coils of a receiver; and
a controller to:
generate a wireless power signal in the one or more transmit coils for wireless power transfer;
terminate the wireless power transfer at least partially responsive to detecting a power loss of the wireless power transfer to be greater than a power loss threshold when a power factor of the wireless power transfer is greater than a power factor threshold; and
refrain from terminating the wireless power transfer at least partially responsive to detecting the power factor to be less than the power factor threshold.

11. The apparatus of claim 10, wherein detecting the power loss to be greater than the power loss threshold when the power factor is greater than the power factor threshold is indicative of foreign object interference.

12. The apparatus of claim 11, wherein detecting the power factor to be less than the power factor threshold is indicative of receiver displacement of the receiver relative to a predetermined charging position associated with the transmitter.

13. The apparatus of claim 10, wherein:
the controller is to:
determine an active power of the wireless power transfer at least partially based on a product of detected coil voltage and detected coil current;
determine a receiver power of the wireless power transfer at least partially based on one or more indications communicated from the receiver; and
determine the power loss at least partially based on a difference between the active power and the receiver power.

14. The apparatus of claim 13, wherein:
the controller is to:
determine an apparent power of the wireless power transfer at least partially based on a product of root mean square (RMS) coil voltage and RMS coil current; and
determine the power loss at least partially based on a ratio of the active power and the apparent power.

15. A method comprising:
at a controller of a transmitter adapted to generate a wireless power signal in one or more transmit coils which inductively couple with one or more receive coils of a receiver for wireless power transfer,
setting a power loss threshold to a first value;
changing the power loss threshold to a second value at least partially responsive to detecting a power factor of the wireless power transfer to be less than a power factor threshold; and
terminating the wireless power transfer at least partially responsive to detecting a power loss of the wireless power transfer to be greater than the power loss threshold.

16. The method of claim 15, wherein changing the power loss threshold to the second value prevents termination of the wireless power transfer.

17. The method of claim 16, wherein changing the power loss threshold to the second value comprises changing the power loss threshold to the second value that is greater than the first value.

18. The method of claim 15, wherein detecting the power loss to be greater than the power loss threshold when the power factor is greater than the power factor threshold is indicative of foreign object interference.

19. The method of claim 18, wherein detecting the power factor to be less than the power factor threshold is indicative of receiver displacement of the receiver.

20. The method of claim 15, comprising:
at the controller of the transmitter,
determining an active power of the wireless power transfer at least partially based on a product of detected coil voltage and detected coil current;
determining a receiver power of the wireless power transfer at least partially based on one or more indications communicated from the receiver; and
determining the power loss at least partially based on a difference between the active power and the receiver power.

21. The method of claim 20, comprising:
at the controller of the transmitter,
determining an apparent power of the wireless power transfer at least partially based on a product of root mean square (RMS) coil voltage and RMS coil current; and
determining the power factor at least partially based on a ratio of the active power and the apparent power.

22. The method of claim 15, wherein changing the power loss threshold to the second value comprises:
computing the power loss threshold at least partially based on a relation of power loss threshold ratios versus power level ratios, respective ones of the power level ratios comprising ratios of power levels after detection of receiver displacement over respective power levels before the receiver displacement, respective ones of the power loss threshold ratios comprising ratios of power loss thresholds after detection of receiver displacement over respective power loss thresholds before the receiver displacement.

23. The method of claim 15, wherein changing the power loss threshold to the second value comprises changing the power loss threshold to the second value at least partially responsive to detecting the power factor to be less than the power factor threshold or an apparent power of the wireless power transfer to be greater than an apparent power threshold.

24. The method of claim 15, comprising:
changing an operating frequency of the wireless power signal at least partially responsive to detecting the power factor to be less than the power factor threshold.

25. The method of claim 24, comprising:
determining whether an efficiency of the wireless power transfer at the changed operating frequency is increased with respect to a previous efficiency of the wireless power transfer; and
repeating the changing of the operating frequency and the determining of whether the efficiency is increased at least partially responsive to determining that the efficiency is not increased with respect to the previous efficiency.

26. The method of claim 23, comprising:
limiting a power level of the wireless power transfer at the changed operating frequency at least partially responsive to determining that an efficiency at the changed operating frequency is increased with respect to a previous efficiency.

27. An apparatus comprising:
a transmitter including:
a transmitter circuitry, the transmitter circuitry including one or more transmit coils to inductively couple with one or more receive coils of a receiver; and
a controller to:
generate a wireless power signal in the one or more transmit coils for wireless power transfer;
determine a power factor of the wireless power transfer at least partially based on a ratio of an active power of the wireless power transfer and an apparent power of the wireless power transfer; and
determine a displaced receiver condition of the receiver at least partially responsive to detecting the power factor to be less than a power factor threshold.

28. The apparatus of claim 27, wherein:
the controller is to:
change an operating frequency of the wireless power signal at least partially responsive to determining the displaced receiver condition.

29. The apparatus of claim 28, wherein:
the controller is to:
determine whether an efficiency of the wireless power transfer at the changed operating frequency is increased with respect to a previous efficiency of the wireless power transfer; and
repeat the changing of the operating frequency and the determining of whether the efficiency is increased at least partially responsive to determining that the efficiency is not increased with respect to the previous efficiency.

30. The apparatus of claim 27, wherein:
the controller is to:
determine a power loss of the wireless power transfer at least partially based on the active power and a receiver power of the receiver;
determine a foreign object interference condition at least partially responsive to detecting the power loss to be greater than a power loss threshold when the power factor is greater than the power factor threshold; and
terminate the wireless power transfer at least partially responsive to determining the foreign object interference condition.
